(19) United States
(12) Patent Application Publication
(10) Pub. No.: US 2015/0171965 A1
(43) Pub. Date: Jun. 18, 2015

(54) OPTICAL LINE TERMINAL AND FRAME TRANSFER METHOD

(71) Applicant: NIPPON TELEGRAPH AND TELEPHONE CORPORATION, Tokyo (JP)

(72) Inventors: Shoko Ohteru, Kanagawa (JP); Tomoaki Kawamura, Kanagawa (JP); Masami Urano, Kanagawa (JP); Mamoru Nakanishi, Kanagawa (JP); Ritsu Kusaba, Kanagawa (JP); Junichi Kato, Kanagawa (JP); Sadayuki Yasuda, Kanagawa (JP); Hiroyuki Uzawa, Kanagawa (JP); Yuki Arikawa, Kanagawa (JP)

(21) Appl. No.: 14/405,395

(22) PCT Filed: Jun. 4, 2013
(86) PCT No.: PCT/JP2013/065455

§ 371 Date: Dec. 3, 2014

(30) Foreign Application Priority Data
Jun. 4, 2012 (JP) 2012-126755

(51) Int. Cl. H04B 10/27

(52) U.S. Cl. CPC H04B 10/27

(57) ABSTRACT

Out of one constantly fed block (B0) and one power saving block (B1) provided by dividing in advance circuit units constituting an OLT (10), a power supply control unit (40) constantly supplies power to circuit units belonging to the constantly fed block. For circuit units belonging to the power saving block, the power supply control unit starts power supply to the power saving block starts in synchronism with the start of the period of an upstream bandwidth allocated to each ONU, and stops the power supply to the power saving block in synchronism with the end of the period of the upstream bandwidth. The power supply control unit starts power supply at a timing specified based on the start timing of the upstream bandwidth, and stops the power supply at a timing decided based on the end timing of the upstream bandwidth. This reduces the power consumption of an overall OLT.

### TECHNICAL FIELD

The present invention relates to an optical communication technology and, more particularly, to a frame transfer technique in an OLT (Optical Line Terminal) that connects a PON system to a host apparatus in a carrier-side network (service network).

### BACKGROUND ART

In 2009, the standardization of 10 G-EPON (10 Gigabit Ethernet Passive Optical Network: “Ethernet” is a registered trademark) in IEEE802.3av was completed. The 10 G-EPON features transfer 10-times faster than GE-PON (Gigabit Ethernet Passive Optical Network: see non-patent literature 1) already in widespread use. In addition, the 10 G-EPON features coexistence with the existing GE-PON.

When the GE-PON and the 10 G-EPON are used in a coexistent state, the WDM technology that uses different wavelengths for a 1 G downstream signal and a 10 G downstream signal is used, and the TDM technology is used between 1 G downstream signals and between 10 G downstream signals. As for upstream signals, a 1 G upstream signal and a 10 G upstream signal use the same wavelength, and the TDMA technology is used for both the 1 G upstream signal and the 10 G upstream signal. That is, three different kinds of wavelengths are used for the 1 G downstream signal, the 10 G downstream signal, and the upstream signal.

### First Related Art

The first related art will be explained with reference to FIGS. 28 to 31.

As shown in FIG. 28, in the conventional 10 G-EPON, the GE-PON and the 10 G-EPON can be used in a coexistent state, so 1 G-ONUs (Optical Network Units) and 10 G-ONUs can be connected to one OLT.

In the conventional OLT, a frame transfer processing unit 60 decides the destination ONU of a downstream frame based on the destination MAC address of the downstream frame. To do this, a MAC address registration unit 61A registers the transmission source MAC address of a received upstream frame in a MAC address search table 61B in association with the LLID (Logical Link ID) of a transmission source ONU that is read out from the preamble of the received upstream frame. A MAC address search unit 61C has a function of, when the destination MAC address of the received downstream frame has already been registered in the MAC address search table 61B, identifying the LLID associated with the MAC address as a destination ONU.

In the OLT shown in FIG. 29, a first transmission/reception circuit 52 is a circuit that transmits/receives a frame to/from the ONU via an ODN (Optical Distribution Network) connected to a PON port 51. A PON is a system that transmits data between the OLT and the ONU via the ODN.

A second transmission/reception circuit 58 is a circuit that serves as an interface to a carrier network NW connected via an SNI (Service Node Interface) port 59 provided on the SNI side.

A frame demultiplexing unit 53 is a processing unit that transmits, out of frames received by the first transmission/reception circuit 52, a frame (control frame used for PON control) addressed to an OLT 50 to a control frame processing unit 54 and transmits the remaining frames to the frame transfer processing unit 60.

A frame multiplexing unit 56 is a processing unit that time-divisionally multiplexes a downstream frame from the frame transfer processing unit 60 and a control frame from the control frame processing unit 54 and transmits them to the first transmission/reception circuit 52.

The frame transfer processing unit 60 is a processing unit that transfers frames received from both the frame demultiplexing unit 53 and the second transmission/reception circuit 58 based on their destination MAC addresses.

The control frame processing unit 54 is a processing unit that performs processes concerning PON control such as a discovery process for assigning an LLID to each ONU and arbitration of an upstream signal (signal addressed to the OLT from an ONU), and processing of transferring PON-IF port information such as the LLID of each ONU to a bandwidth allocation processing unit 55.

The bandwidth allocation processing unit 55 is a processing unit that performs, in accordance with a request from the control frame processing unit 54, processing of allocating a bandwidth (transmission start time and transmission data amount) to an ONU, and processing of managing PON-IF port information transferred from the control frame processing unit 54.

In the frame transfer processing unit 60 shown in FIG. 30, a MAC address processing unit 61 registers/searches for a MAC address. In the MAC address processing unit 61, the MAC address registration unit 61A searches the MAC address search table 61B based on the transmission source MAC address of a received upstream frame. If the transmission source MAC address is not registered in the MAC address search table 61B, the MAC address is newly registered. If the transmission source MAC address has already been registered in the MAC address search table 61B, the registered information is updated (if the registered information need not be updated, updating may be skipped) by overwriting, with the transmission source MAC address of the received upstream frame, and an LLID and downstream transmission rate information read out from the received upstream frame, a storage area where the same registered MAC address as the transmission source MAC address of the received upstream frame, and an LLID and downstream transmission rate information associated with the registered MAC address are stored.

The LLID of an GNU corresponding to each transmission source MAC address is registered in the MAC address search table 61B.

Based on the destination MAC address of a received downstream frame, the MAC address search unit 61C reads out a corresponding LLID from the MAC address search table 61B, and decides the LLID to be embedded to the downstream frame.

A latency compensation unit 61D adds a delay to the received downstream frame to compensate the latency generated by LLID decision processing in the MAC address search unit 61C.

An output composition unit 61E embeds the LLID decided by the MAC address search unit 61C into the preamble of the downstream frame output from the latency compensation unit 61D, thereby giving the destination LLID to the downstream frame to be transmitted.

In the 10 G-EPON system, even when downstream frames addressed to a 1 G-ONU and a 10 G-GNU coexist, the LLIDs of destination ONUs can be decided in the same way. It is necessary to separately confirm what kind of ONU should have each LLID and transmit the frame from the downstream frame output of a corresponding rate. However, the conventional OLT does not have such a function.

FIG. 31 shows the arrangement of the main part after change to which a downstream transmission rate processing unit is added, as the main part of frame transfer processing used in a conventional 1 G-EPON OLT.

In the conventional OLT, when adding a circuit that decides the LLID of a destination ONU from the destination MAC address of a downstream frame, decides downstream transmission rate information from the LLID, and adds these pieces of information to the downstream frame (that is, when supporting 10 G-EPON by the 1 G-EPON OLT), the frame transfer processing unit 60 supposedly requires a downstream transmission rate processing unit 62 as shown in FIG. 31.

Based on the destination MAC address of a received downstream frame, the MAC address search unit 61C reads out a corresponding LLID from the MAC address search table 61B, and decides the LLID to be embedded to the downstream frame.

The first latency compensation unit 61D adds a delay to the received downstream frame to compensate the latency generated by LLID decision processing in the MAC address search unit 61C.

The first output composition unit 61E embeds the LLID decided by the MAC address search unit 61C into the preamble of the downstream frame output from the first latency compensation unit 61D, thereby giving the destination LLID to the downstream frame to be transmitted.

A downstream transmission rate search unit 62C reads out corresponding downstream transmission rate information from a downstream transmission rate management table 62B based on the embedded destination LLID, and decides the downstream transmission rate of the downstream frame.

A second latency compensation unit 62D adds a delay to the received downstream frame to compensate the latency generated by downstream transmission rate decision processing in the downstream transmission rate search unit 62C.

A second output composition unit 62E embeds the downstream transmission rate information decided by the downstream transmission rate search unit 62C into the preamble of the downstream frame output from the second latency compensation unit 62D, thereby giving the downstream transmission rate information to the downstream frame to be transmitted.

Referring to FIG. 31, a rate information registration unit 62A reads out the LLID of a transmission source GNU from the preamble of a received upstream frame, reads out downstream transmission rate information corresponding to the LLID of the transmission source ONU from the bandwidth allocation processing unit 55, and registers the LLID and the downstream transmission rate information in the downstream transmission rate management table 62B in association with each other.

Downstream transmission rate information corresponding to the LLID of each ONU is registered in the downstream transmission rate management table 62B.

The downstream transmission rate search unit 62C reads out downstream transmission rate information from the downstream transmission rate management table 62B based on the destination LLID of a downstream frame, and decides the downstream transmission rate information of the downstream frame to be transmitted.

The second latency compensation unit 62D adds a delay to the downstream frame having the added destination LLID, thereby compensating the latency generated by downstream transmission rate decision processing in the downstream transmission rate search unit 62C.

The second output composition unit 62E embeds the downstream transmission rate information read out by search in the downstream transmission rate search unit 62C to the downstream frame output from the second latency compensation unit 62D.

The downstream frame is sent to the PON at a predetermined rate in accordance with the given downstream transmission rate information.

Note that in FIG. 31, an upstream frame, and downstream transmission rate information from the bandwidth allocation processing unit 55 are input to the rate information registration unit 62A. However, the registration circuit (rate information registration unit 62A) is not always necessary. Since software configured to control and manage the OLT 50 holds downstream transmission rate information corresponding to each LLID, this software can write necessary information in the downstream transmission rate management table 62B.

### Second Related Art

Next, the second related art will be explained with reference to FIGS. 32 and 33.

In a conventional PON system, the OLT has one SNI (Service Node Interface) port on the SNI side, as described in non-patent literature 2.

If it is necessary to change a network (service network) to be connected for each ONU (Optical Network Unit), the conventional PON system takes a system configuration as shown in FIG. 32 or 33. Of these configurations, the system configuration in FIG. 32 is a configuration example in which one OLT is provided for each network (service network) NW. The system configuration in FIG. 33 is a configuration example in which a switch (or a router or the like) is interposed between an OLT and a plurality of networks NW to connect the plurality of networks NW to one OLT. The OLTs used in these PON systems are the same as the OLT shown in FIG. 28 described above.

In both the system configurations of FIGS. 32 and 33, a host apparatus that performs transfer control and the like in the service network is embedded between the SNI and the network NW. At this time, the host apparatus connected to the OLT restricts the contents of services implementable in the PON system. For example, when the host apparatus connected to the OLT is 1 G Ethernet, this PON system is restricted to 1 G Ethernet-based services.

In the case of FIG. 33, one switch and one OLT are shared between a plurality of host apparatuses, that is, the bandwidth of one OLT is divisionally used. This makes the bandwidth of a downstream frame usable in each host apparatus be narrower than that in the case of FIG. 32.

That is, when the network NW to be connected changes for each GNU, two methods are available conventionally. The respective methods have advantages and disadvantages: Method 1 (FIG. 32): the downstream bandwidth usable in each host apparatus can be maximized, but OLTs are necessary by the number of networks NW to be connected.

Method 2 (FIG. 33): the downstream bandwidth usable in each host apparatus becomes narrower (the downstream bandwidth of the host apparatus cannot be used maximally) than that in method 1 (FIG. 32), but only one OLT is necessary.

### RELATED ART LITERATURE

### Patent Literature

Patent Literature 1: Japanese Patent Laid-Open No. 2009-260668

### Non-Patent Literature

Non-Patent Literature 1: “Lecture on Basic Technologies [GE-PON Technology] Part 1, What Is PON?”, NTT Technical Review, Vol. 17, No. 8, pp. 71-74, 2005
Non-Patent Literature 2: “Development of Gigabit Ethernet-PON (GE-PON) System”, NTT Technical Review, Vol. 17, No. 3, pp. 75-80, 2005
Non-Patent Literature 3: “Lecture on Basic Technologies [GE-PON Technology] Part 3, DBA Function”, NTT Technical Review, Vol. 17, No. 10, pp. 67-70, 2005

### DISCLOSURE OF INVENTION

### Problem to be Solved by the Invention

In the OLT, some of circuit units constituting the OLT are not constantly used, and some circuit units are not used in a specific period in accordance with the operating state of the OLT. For example, when the OLT has a so-called DBA (Dynamic Bandwidth Allocation) function of allocating, to an ONU based on the amount of upstream data waiting for transmission that is notified from an ONU, an upstream bandwidth used to transmit an upstream frame from the ONU, a period in which no upstream frame is transmitted exists. In this period, for example, a reception circuit is not used.

However, the conventional OLT is configured to constantly supply power to the circuit units constituting the OLT, and thus wastes power.

The present invention has been made to solve the above-described problems, and has as its object to provide a frame transfer technique capable of reducing the power consumption of the overall OLT.

### Means of Solution to the Problem

To achieve this object, according to the present invention, there is provided an OLT comprising a reception circuit that receives upstream frames from a plurality of ONUs connected via a PON in periods of upstream bandwidths individually allocated to the respective ONUs, one or a plurality of transmission circuits that are provided for respective preset downstream transmission rates and transmit downstream frames to the ONUs via the PON at the downstream transmission rates, a transmission/reception circuit that transmits the upstream frame to a host apparatus connected via an SNI (Service Node Interface) and receives the downstream frame from the host apparatus via the SNI, a frame demultiplexing unit that demultiplexes the upstream frame received by the reception circuit into an SNI upstream frame to be transferred to the SNI side and a non-SNI upstream frame unnecessary to be transferred to the SNI side, a frame transfer processing unit that transfers the SNI upstream frame demultiplexed by the frame demultiplexing unit to the transmission/reception circuit, and transfers the downstream frame received by the transmission/reception circuit to the transmission circuit, and a power supply control unit that selectively supplies power to a power saving block constituted by at least one circuit unit used for reception processing of the upstream frame, out of circuit units including the reception circuit, the plurality of transmission circuits, the transmission/reception circuit, the frame demultiplexing unit, and the frame transfer processing unit which constitute the OLT, and constantly supplies power to a constantly fed block constituted by a circuit unit other than the power saving block, wherein when supplying power to the power saving block, the power supply control unit starts power supply in synchronism with a start of the period of the upstream bandwidth of each GNU, and stops the power supply in synchronism with an end of the period of the upstream bandwidth.

According to the present invention, there is also provided a frame transfer method comprising the step of causing a reception circuit to receive upstream frames from a plurality of ONUs connected via a PON in periods of upstream bandwidths individually allocated to the respective ONUs, the step of causing transmission circuits provided for respective preset downstream transmission rates to transmit downstream frames to the ONUs via the PON at the downstream transmission rates, the step of causing a transmission/reception circuit to transmit the upstream frame to a host apparatus connected via an SNI (Service Node Interface), the step of causing the transmission/reception circuit to receive the downstream frame from the host apparatus via the SNI, the step of causing a frame demultiplexing unit to demultiplex the upstream frame received by the reception circuit into an SNI upstream frame to be transferred to the SNI side and a non-SNI upstream frame unnecessary to be transferred to the SNI side, the step of causing a frame transfer processing unit to transfer the SNI upstream frame demultiplexed by the frame demultiplexing unit to the transmission/reception circuit, the step of causing the frame transfer processing unit to transfer the downstream frame received by the transmission/reception circuit to the transmission circuit, the power saving supply step of causing a power supply control unit to selectively supply power to at least one circuit unit that is included in a power saving block, out of circuit units including the reception circuit, the plurality of transmission circuits, the transmission/reception circuit, the frame demultiplexing unit, and the frame transfer processing unit which constitute the OLT, and is used for reception processing of the upstream frame, and the step of causing the power supply control unit to constantly supply power to, of the circuit units, a circuit unit included in a constantly fed block other than the power saving block, the power saving supply step including the step of starting power supply to the power saving block in synchronism with a start of the period of the upstream bandwidth of each ONU, and the step of stopping the power supply to the power saving block in synchronism with an end of the period of the upstream bandwidth of the ONU.

### Effect of the Invention

According to the present invention, power is supplied to the power saving block in synchronism with the period of an upstream bandwidth allocated to each ONU, and the power supply to the power saving block is stopped in the remaining period. When there is an unused upstream bandwidth in the PON-IF, power supply to circuits concerning reception of an upstream frame can be stopped in the period of the unused bandwidth. This can reduce the power consumption in the circuit units concerning reception of an upstream frame, and can reduce the power consumption of the overall OLT.

### BRIEF DESCRIPTION OF DRAWINGS

FIG. 1 is a block diagram showing the arrangement of a PON system according to the first embodiment;

FIG. 2 shows an example of the structure of a frame transmitted in a PON section;

FIG. 3 is a block diagram showing the arrangement of an OLT according to the first embodiment;

FIG. 4 is a block diagram showing an example of the arrangement of a frame transfer processing unit according to the first embodiment;

FIG. 5 shows an example of the structure of a MAC address search table;

FIG. 6 is a flowchart showing a downstream frame output destination decision procedure;

FIG. 7 shows an example of the structure of an LLID table;

FIG. 8 is a flowchart showing an upstream frame output destination SNI decision procedure;

FIG. 9 is a timing chart showing the stop/start of power supply to a power saving block according to the first embodiment;

FIG. 10 is a timing chart showing the stop/start of power supply to a power saving block according to the second embodiment;

FIG. 11 is a block diagram showing the arrangement of an OLT according to the third embodiment;

FIG. 12 is a block diagram showing an example of the arrangement of a frame transfer processing unit according to the third embodiment;

FIG. 13 is a timing chart showing the stop/start of power supply to a power saving block and a frame transfer power saving block according to the third embodiment;

FIG. 14 is a block diagram showing the arrangement of an OLT according to the fourth embodiment;

FIG. 15 shows an example of the structure of an upstream frame output from an upstream input unit;

FIG. 16 is a flowchart showing a MAC address registration procedure;

FIG. 17 shows an example of the structure of a MAC address search table according to the fifth embodiment;

FIG. 18 is a flowchart showing a MAC address registration procedure according to the fifth embodiment;

FIG. 19 is a flowchart showing an aging processing procedure;

FIG. 20 is a timing chart showing transition of an entry in the MAC address search table;

FIG. 21 is a block diagram showing the arrangement of a frame transfer processing unit according to the sixth embodiment;

FIG. 22 shows an example of the structure of a VID table;

FIG. 23 is a flowchart showing a downstream frame output destination decision procedure;

FIG. 24 is a block diagram showing the arrangement of an OLT according to the seventh embodiment;

FIG. 25 is a block diagram showing the arrangement of an OLT according to the eighth embodiment;

FIG. 26 is a block diagram showing an example of the arrangement of a frame transfer processing unit according to the eighth embodiment;

FIG. 27 is a timing chart showing the stop/start of power supply to respective power saving blocks according to the eighth embodiment;

FIG. 28 shows an example of the arrangement of a conventional 10 G-EPON system;

FIG. 29 is a block diagram showing the arrangement of a conventional OLT;

FIG. 30 is a block diagram showing the arrangement of the main part of frame transfer processing used in the conventional OLT;

FIG. 31 is a block diagram showing the arrangement (after change) of the main part of frame transfer processing used in a conventional 1 G-EPON OLT;

FIG. 32 shows another example of the arrangement of the conventional 10 G-EPON system; and

FIG. 33 shows another example of the arrangement of the conventional 10 G-EPON system.

### BEST MODE FOR CARRYING OUT THE INVENTION

Embodiments of the present invention will now be described with reference to the accompanying drawings.

### First Embodiment

### PON System

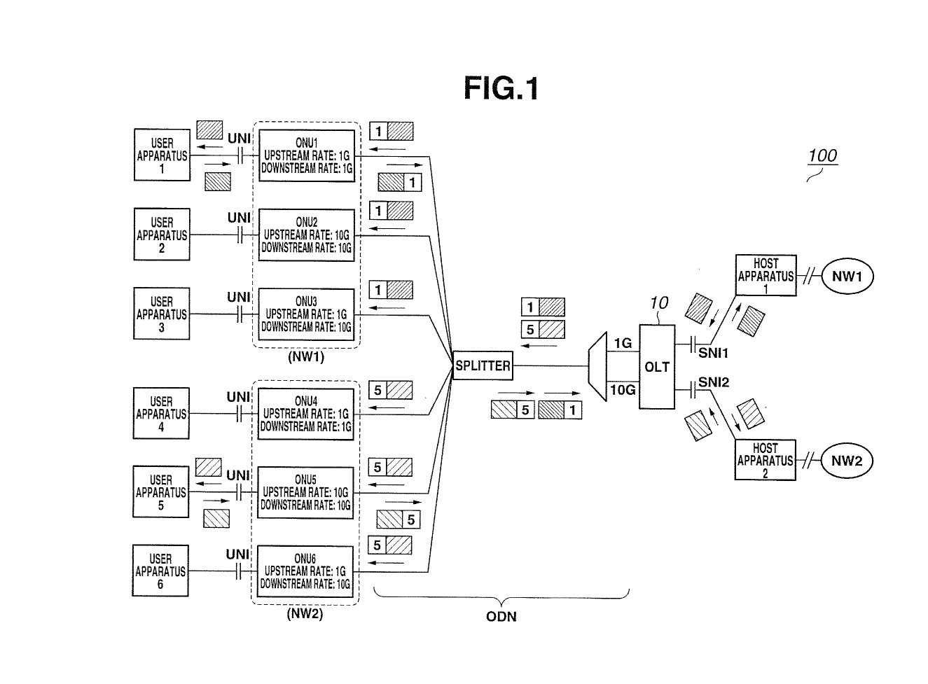

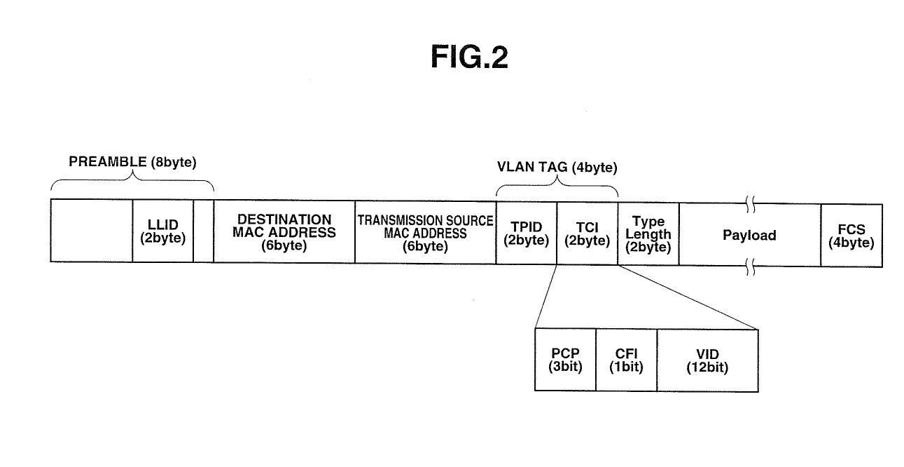

A PON system 100 according to the first embodiment of the present invention will be described first with reference to FIGS. 1 and 2.

As shown in FIG. 1, in the PON system 100, an ONUn (n=1 to 6) is connected to a user apparatus n via a UNI (User Network Interface).

The respective ONUs are commonly connected to one optical splitter via optical communication channels. The optical splitter is connected to one OLT 10 via one optical communication channel and an optical multiplexing/demultiplexing device.

The OLT 10 has two SNI ports on the SNI side, and host apparatuses 1 and 2 are individually connected to the respective SNI ports via SNIs.

A carrier-side network (service network) NW1 is connected to the host apparatus 1, and a carrier-side network (service network) NW2 is connected to the host apparatus 2.

Data are exchanged in the PON section of the PON system 100, that is, the section between the ONUn and the OLT 10 by using a frame having a structure as shown in FIG. 2.

Referring to FIG. 2, the preamble is formed by embedding an LLID in the preamble of Ethernet.

The LLID (Logical Link ID) is an identifier provided in a one-to-one correspondence with each ONU for unicast and in a one-to-many correspondence with each ONU for multicast or broadcast. The LLID is decided by the OLT when registering an ONU (placing an ONU under the OLT). The OLT manages the LLIDs without repetition among ONUs under it.

A VLAN tag is a tag including VLAN information. The tag may be absent, or a plurality of tags may be added. The VLAN tag includes TPID and TCI.

TPID (Tag Protocol ID) is an Ether Type value representing that a VLAN tag follows. Normally, the TPID is 0x8100 representing an IEEE802.1Q tagged frame. TCI (Tag Control Information) is VLAN tag information. The TCI includes PCP, CFI, and VID.

PCP (Priority Code Point) is the priority of the frame.

CFI (Canonical Format Indicator) is a value representing whether the MAC address in the MAC header complies with a standard format.

VID or VLAN ID (VLAN Identifier) is a value that designates a VLAN to which the frame belongs.

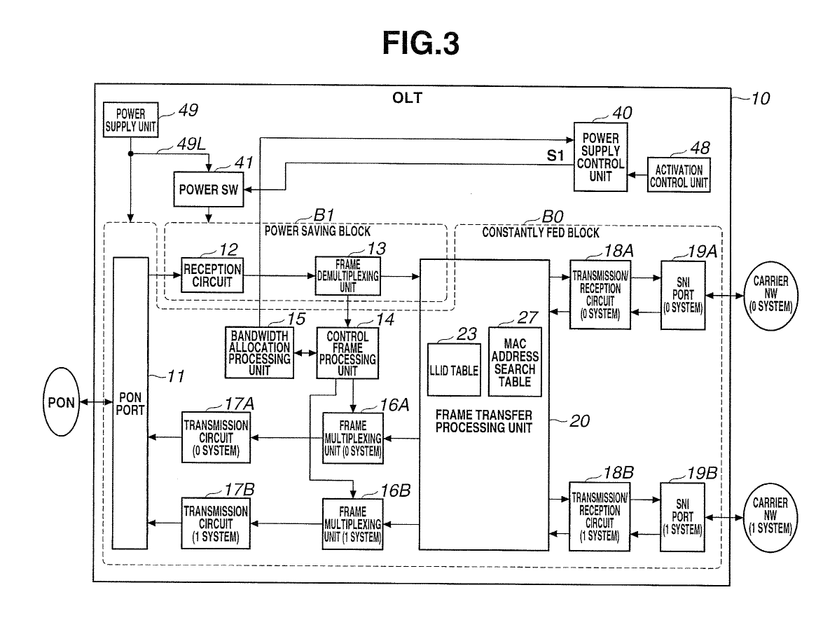

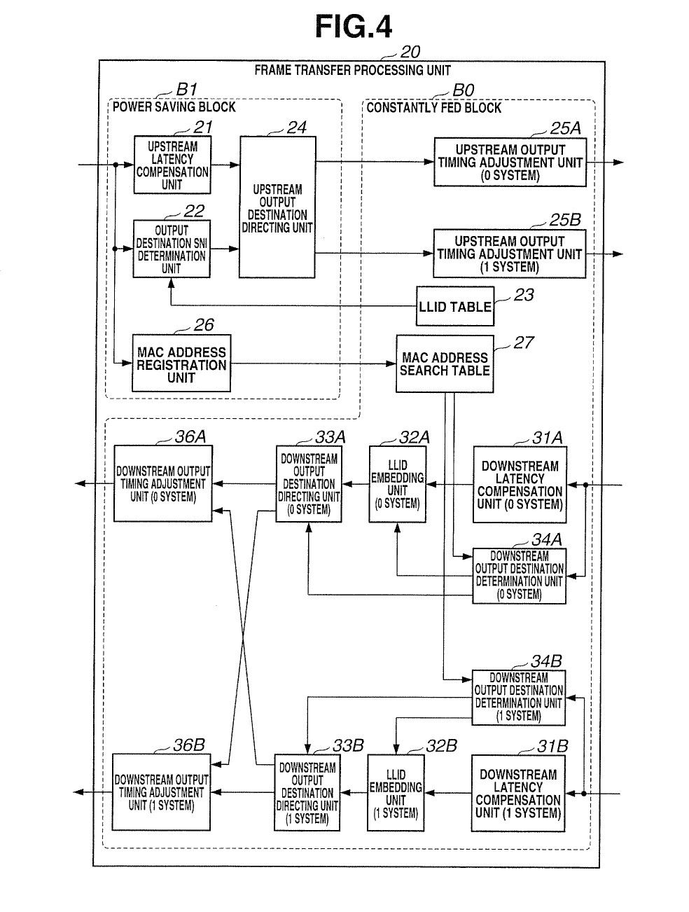

Type is an Ether Type value representing the type of the host protocol.

[OLT] The arrangement of the OLT 10 according to this embodiment will be described next with reference to FIGS. 3 and 4.

The OLT 10 according to this embodiment has a function of connecting to a plurality of ONUs via the PON, connecting to a plurality of host apparatuses via SNIs (Service Node Interfaces) provided for the respective host apparatuses, mutually transferring frames to be exchanged between the ONUs and the host apparatuses, and allocating, to the respective ONUs, upstream bandwidths used to transmit upstream frames from the ONUs.

The OLT 10 is different in the arrangement from the conventional OLT in that an SNI port, a transmission/reception circuit, a frame multiplexing unit, and a transmission circuit are provided for each of transmission systems of different downstream transmission rates, and the OLT 10 includes a frame transfer processing unit having an arrangement corresponding to the SNI port, the transmission/reception circuit, the frame multiplexing unit, and the transmission circuit provided for each of the different transmission systems. Also, the OLT 10 includes a power supply control unit 40 that controls power supply to a power saving block.

The processing units of the OLT 10 according to this embodiment will be described with reference to FIG. 3.

A PON port 11 is a circuit that exchanges frames with the ONUs via the ODN.

A reception circuit 12 is a circuit that receives upstream frames from the ONUs via the ODN and the PON port 11.

A transmission circuit (0 system) 17A and a transmission circuit (1 system) 17B are circuits that are provided for preset downstream transmission rates and transmit downstream frames to an ONU (0 system) and an ONU (1 system) at these downstream transmission rates via the PON port 11 and the ODN. In the present invention, the 0 system represents a transmission system having a downstream transmission rate of 1 Gbps, and the 1 system represents a transmission system having a downstream transmission rate of 10 Gbps.

An SNI port (0 system) 19A and an SNI port 19B (1 system) are circuit units that are provided for respective host apparatuses and exchange frames with the host apparatuses via the SNIs.

A transmission/reception circuit (0 system) 18A and a transmission/reception circuit (1 system) 18B are circuit units that are provided for the respective host apparatuses, that is, the respective SNIs, and transmit/receive frames to/from the carrier network (0 system) NW1 and the carrier network (1 system) NW2 via the SNI ports 19A and 19B and the corresponding host apparatuses 1 and 2, respectively.

A frame demultiplexing unit 13 is a processing unit that demultiplexes a frame input from the reception circuit 12 into an SNI upstream frame to be transferred to the SNI side and a non-SNI upstream frame unnecessary to be transferred to the SNI side, transmits the SNI upstream frame to a frame transfer processing unit 20, and transmits the non-SNI upstream frame to a control frame processing unit 14. The SNI upstream frame is, e.g., an upstream data frame including upstream data addressed to a host apparatus from a user apparatus. The non-SNI frame is, e.g., a frame addressed to the OLT 10 (control frame used for PON control).

A frame multiplexing unit (0 system) 16A is a processing unit that time-divisionally multiplexes a downstream frame addressed to the ONU (0 system) from the frame transfer processing unit 20 and a control frame addressed to the ONU (0 system) from the control frame processing unit 14, and transmits them to the transmission circuit (0 system) 17A.

A frame multiplexing unit (1 system) 16B is a processing unit that time-divisionally multiplexes a downstream frame addressed to the ONU (1 system) from the frame transfer processing unit 20 and a control frame addressed to the ONU (1 system) from the control frame processing unit 14, and transmits them to the transmission circuit (1 system) 17B.

The frame transfer processing unit 20 is a processing unit that transfers an upstream frame received by the reception circuit 12 and input from the frame demultiplexing unit 13 to either the transmission/reception circuit 18A or 18B (0 system or 1 system) based on the LLID of the upstream frame read out from an LLID table 23 and corresponding SNI selection information, and transfers a downstream frame received by the transmission/reception circuit 18A or 18B to either the frame multiplexing unit 16A or 16B (0 system or 1 system) based on the destination MAC address of the downstream frame read out from a MAC address search table 27 and corresponding downstream output destination selection information.

The control frame processing unit 14 is a processing unit that performs processes concerning PON control such as a discovery process for assigning an LLID to each ONU and arbitration of an upstream signal (signal addressed to the OLT from an ONU).

A bandwidth allocation processing unit 15 is a processing unit that performs, in accordance with a request from the control frame processing unit 14, allocation of a bandwidth (transmission start time and transmission data amount) to an ONU and management of PON-IF port information transferred from the control frame processing unit 14.

In this embodiment, one or more constantly fed blocks and one or more power saving blocks are provided in advance as blocks that perform power control of circuit units constituting the OLT 10. In the arrangement example of FIG. 3, the circuit units constituting the OLT 10 are divided into one constantly fed block B0 and one power saving block B1.

The constantly fed block B0 is a block to which power is constantly fed when the OLT 10 is used. The PON port 11, the control frame processing unit 14, the bandwidth allocation processing unit 15, the frame multiplexing unit (0 system) 16A, the frame multiplexing unit (1 system) 16B, the transmission circuit (0 system) 17A, the transmission circuit (1 system) 17B, the transmission/reception circuit (0 system) 18A, the transmission/reception circuit (1 system) 18B, the SNI port (0 system) 19A, the SNI port (1 system) 19B, and part of the frame transfer processing unit 20 belong to the constantly fed block B0.

The power saving block B1 is a block, power supply to which can be stopped when the upstream bandwidth is not used. The reception circuit 12, the frame demultiplexing unit 13, and some of circuits concerning reception of an upstream frame in the frame transfer processing unit 20 belong to the power saving block B1.

A power supply unit 49 has a function of supplying power to the constantly fed block B0 via a power supply line 49L, and a function of supplying power to the power saving block B1 to the power supply line 49L and a power switch 41.

The bandwidth allocation processing unit 15 transmits, to the power supply control unit 40, power saving information representing a power supply start instruction and power supply stop instruction in accordance with the period of an upstream bandwidth that is specified from upstream bandwidth allocation information allocated in advance to each ONU and allocated to the ONU. The upstream bandwidth allocation information allocated in advance includes, for example, the upstream transmission start time and transmission amount allocated to each ONU when the ONU notifies the amount of data waiting for transmission by a REPORT frame, as shown in FIG. 3 of non-patent literature 3.

The power supply control unit 40 has a function of controlling opening/closing of the power switch 41 by outputting a control signal S1 based on power saving information transmitted from the bandwidth allocation processing unit 15.

Next, the processing units of the frame transfer processing unit 20 according to this embodiment will be explained with reference to FIG. 4.

An upstream latency compensation unit 21 is a circuit that adds a delay to a received upstream frame to compensate the latency generated by output destination SNI decision processing in an upstream output destination determination unit 22.

The upstream output destination determination unit 22 is a circuit that reads out SNI selection information from the LLID table 23 based on the LLID of a received upstream frame, and decides an output destination SNI.

SNI selection information and entry enable/disable are registered in the LLID table 23 for the LLID of each GNU.

An upstream output destination directing unit 24 is a circuit that transfers an upstream frame from the upstream latency compensation unit 21 to a corresponding upstream output timing adjustment unit 25A or 25B in accordance with the SNI selection information decided by the output destination SNI determination unit 22.

A MAC address registration unit 26 is a circuit that searches the MAC address search table 27 based on the transmission source MAC address of a received upstream frame, when the transmission source MAC address has not been registered in the MAC address search table 27, newly registers the transmission source MAC address, and when the transmission source MAC address has already been registered in the MAC address search table 27, updates (maintains) the registration information of the MAC address.

In the MAC address search table 27, the downstream output destination selection information, LLID, and entry enable/disable are registered in the MAC address search table 27 for the MAC address of each user apparatus connected to an ONU or that of each ONU.

The upstream output timing adjustment units 25A and 25B are circuits that are provided for the respective transmission/reception circuits 18A and 18B, adjust the output order of upstream frames based on priority determined by PCP included in the upstream frames or the like, and transfer the upstream frames from the upstream output destination directing unit 24 to the corresponding transmission/reception circuits 18A and 18B.

Downstream latency compensation units 31A and 31B are circuits that are provided for the respective transmission/reception circuits 18A and 18B, and add delays to received downstream frames to compensate the latencies generated by LLID decision processing and downstream output destination decision processing in downstream output destination determination units 34A and 34B.

The downstream output destination determination units 34A and 34B are circuits that are provided for the respective transmission/reception circuits 18A and 18B, read out corresponding LLIDs and pieces of downstream output destination selection information from the MAC address search table 27 based on the destination MAC addresses of received downstream frames, and decide the LLIDs to be embedded to the downstream frames and the output destinations of the downstream frames.

LLID embedding units 32A and 32B are circuits that are provided for the respective transmission/reception circuits 18A and 18B, and embed destination LLIDs to downstream frames from the downstream latency compensation units 31A and 31B in accordance with the LLIDs decided by the downstream output destination determination units 34A and 34B.

Downstream output destination directing units 33A and 33B are circuits that are provided for the respective transmission/reception circuits 18A and 18B, and transfer downstream frames from the LLID embedding units 32A and 32B to the transmission circuits 17A and 17B corresponding to pieces of downstream output destination selection information via a downstream output timing adjustment unit 36A of the 0 system or a downstream output timing adjustment unit 36B of the 1 system in accordance with the pieces of downstream output destination selection information decided by the downstream output destination determination units 34A and 34B.

The downstream output timing adjustment units 36A and 36B are circuits that are provided for respective downstream transmission rates (downstream transmission systems), adjust the output order of downstream frames based on priority determined by PCP included in the downstream frames or the like, and transfer the downstream frames to the corresponding transmission circuits 17A and 17B via the corresponding frame multiplexing units 16A and 16B.

The processing units of the frame transfer processing unit 20 are also divided into one constantly fed block B0 and one power saving block B1, similarly to the circuit units constituting the OLT 10.

Of these processing units, the upstream latency compensation unit 21, the upstream output destination determination unit 22, the upstream output destination directing unit 24, and the MAC address registration unit 26 are circuits concerning reception of an upstream frame whose time of arrival in the OLT is known, and thus power supply to them can be stopped in a period in which the upstream bandwidth is not used.

Thus, the upstream latency compensation unit 21, the upstream output destination determination unit 22, the upstream output destination directing unit 24, and the MAC address registration unit 26 belong to the power saving block B1, power supply to which can be stopped when the upstream bandwidth is not used.

In contrast, the upstream output timing adjustment units 25A and 25B temporarily hold upstream frames in buffers in order to adjust the output order, and thus constantly require supply of power.

The LLID table 23 and the MAC address search table 27 constantly require supply of power in order to hold registration information.

The downstream latency compensation units 31A and 31B, the downstream output destination determination units 34A and 34B, the LLID embedding units 32A and 32B, downstream output destination directing units 33A and 33B, and the downstream output timing adjustment units 36A and 36B are circuits concerning reception of a downstream frame that arrives in the OLT without notice, and constantly require supply of power.

For this reason, the upstream output timing adjustment units 25A and 25B, the LLID table 23, the MAC address search table 27, the downstream latency compensation units 31A and 31B, the downstream output destination determination units 34A and 34B, the LLID embedding units 32A and 32B, the downstream output destination directing units 33A and 33B, and the downstream output timing adjustment units 36A and 36B belong to the constantly fed block B0 to which power is constantly supplied when the OLT 10 is used.

### Operation According to First Embodiment

Next, frame transfer processing in the OLT 10 according to this embodiment will be described in detail with reference to FIGS. 4 to 8.

An operation of deciding the output destination of a downstream frame by the frame transfer processing unit 20 will be explained first.

In the following way, the frame transfer processing unit 20 decides which of the transmission circuits 17A and 17B should transmit a received downstream frame, that is, to which of downstream systems of different rates a received downstream frame should be output.

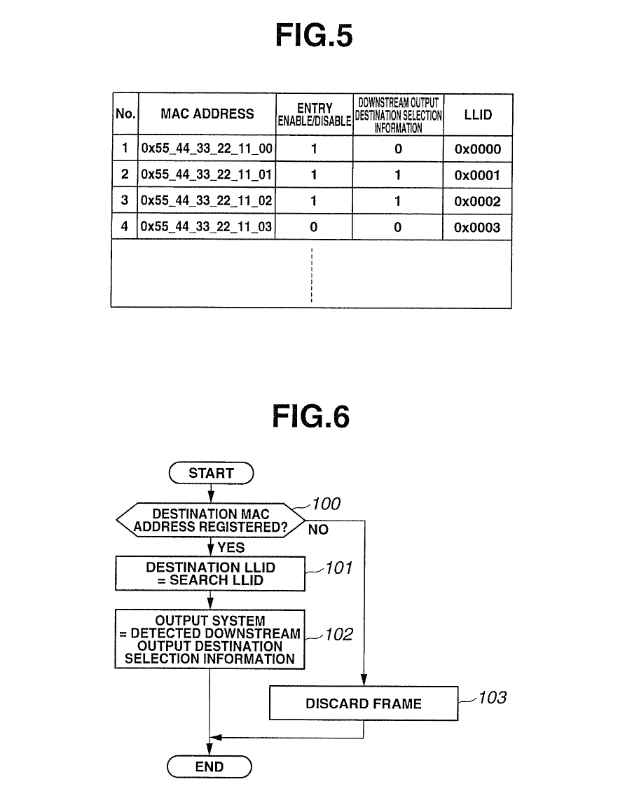

The frame transfer processing unit 20 includes the MAC address search table 27 shown in FIG. 5. Downstream output destination selection information, LLID, and entry enable/disable are registered in the MAC address search table 27 for the MAC address of each user apparatus connected to an ONU or that of each ONU. Entry enable/disable is information representing the enable/disable state of the entry. “Disable” represents that “this entry is free”, that is, even if certain values are described in the MAC address, downstream output destination selection information, and LLID of this entry, these values are unusable for output destination determination, and write is unconditionally possible.

The downstream output destination determination units 34A and 34B are provided for the respective transmission/reception circuits 18A and 18B. The downstream output destination determination units 34A and 34B read out LLIDs and pieces of downstream output destination selection information from the MAC address search table 27 based on the destination MAC addresses of received downstream frames, and decide the destination LLIDs and output destinations of the downstream frames according to a procedure in FIG. 6. The decided LLID information is supplied as a destination LLID to the LLID embedding unit (0 system) 32A or LLID embedding unit (1 system) 32B serving as a corresponding system.

In the downstream frame downstream output destination decision procedure shown in FIG. 6, the downstream output destination determination units 34A and 34B first confirm, based on the entry enable/disable of the destination MAC addresses of received downstream frames in the MAC address search table 27, whether the destination MAC addresses have been registered in the MAC address search table 27 (step 100).

If the “enable” state has been set as the entry enable/disable, and the destination MAC addresses have been registered (step 100: YES), the downstream output destination determination units 34A and 34B read out LLIDs corresponding to the destination MAC addresses from the MAC address search table 27, and specify them as the destination LLIDs of the downstream frames (step 101).

Subsequently, the downstream output destination determination units 34A and 34B read out pieces of downstream output destination selection information corresponding to the destination MAC addresses from the MAC address search table 27, specify the output systems of the downstream frames (step 102), and end the series of processes.

If the MAC address fields do not match the destination MAC addresses in any entry where the “enable” state is set as the entry enable/disable (step 100: NO), the downstream output destination determination units 34A and 34B decide to discard the downstream frames (step 103), and end the series of processes.

In parallel to the downstream frame downstream output destination decision procedure, the downstream latency compensation units 31A and 31B provided for the respective transmission/reception circuits 18A and 18B add, to the received downstream frames, the same delays as the latencies generated in the downstream output destination determination units 34A and 34B, thereby compensating the latencies generated by downstream output destination decision processing in the downstream output destination determination units 34A and 34B.

The LLID embedding units 32A and 32B are provided for the respective transmission/reception circuits 18A and 18B. The LLID embedding units 32A and 32B embed the destination LLIDs to the downstream frames from the downstream latency compensation units 31A and 31B in accordance with the LLIDs decided by the downstream output destination determination units 34A and 34B.

The downstream output destination directing units 33A and 33B are provided for the respective transmission/reception circuits 18A and 18B. In accordance with the pieces of downstream output destination selection information decided by the downstream output destination determination units 34A and 34B, the downstream output destination directing units 33A and 33B transfer the downstream frames from the LLID embedding units 32A and 32B to the transmission circuits 17A and 17B corresponding to the pieces of downstream output destination selection information via the downstream output timing adjustment unit 36A of the 0 system or the downstream output timing adjustment unit 36B of the 1 system.

The downstream output timing adjustment units 36A and 36B are provided for respective downstream transmission rates (downstream transmission systems). The downstream output timing adjustment units 36A and 36B adjust the output order of the downstream frames based on priority determined by PCP included in the downstream frames or the like, and transfer the downstream frames to the corresponding transmission circuits 17A and 17B via the corresponding frame multiplexing units 16A and 16B. For example, in a system in which a 10 G-ONU and a 1 G-ONU coexist, 10 G (802.3av specifications) output is designated for the 10 G-ONU, and 1 G (802.3ah specifications) output is designated for the 1 G-ONU.

If the downstream output destination determination units 34A and 34B determine to discard the downstream frames, the downstream output destination directing units 33A and 33B discard the downstream frames.

A system in which GE-PON and 10 G-EPON coexist is an example of a case in which a downstream frame is transferred from the downstream output destination directing unit 33A of the 0 system to the downstream output timing adjustment unit 36B of the 1 system, or a downstream frame is transferred from the downstream output destination directing unit 33B of the 1 system to the downstream output timing adjustment unit 36A of the 0 system. In the present invention, the 0 system represents a transmission system having a downstream transmission rate of 1 Gbps, and the 1 system represents a transmission system having a downstream transmission rate of 10 Gbps.

In this case, when a destination user apparatus for a downstream frame that has been input from the SNI port (1 system) and has a downstream transmission rate of 10 Gbps is placed under an ONU for GE-PON, the OLT 10 needs to output the downstream frame from the PON port 11 as a GE-PON frame having a downstream transmission rate of 1 Gbps.

To do this, the frame transfer processing unit 20 needs to output, from the 0 system, the downstream frame received from the 1 system. This technique is necessary in transition from GE-PON to 10 G-EPON.

As for the MAC address search table 27, the MAC address registration unit 26 reads out a transmission source MAC address and an LLID from a received upstream frame, and registers the LLID and downstream output destination selection information corresponding in advance to the LLID in the MAC address search table 27 in association with the transmission source MAC address. As the downstream output destination selection information, for example, downstream output destination selection information of an ONU is read out by a control frame notified from the ONU at the start of communication.

In the arrangement of this embodiment, values in the MAC address search table 27 are set by software that controls and manages the OLT 10. More specifically, when the MAC address registration unit 26 sets, in a register, information to be registered in the MAC address search table 27 as shown in FIG. 5, and sets a MAC address setting request flag, the software writes the information in the MAC address search table 27 and sets a MAC address setting completion flag. In this way, the destination MAC address and downstream output destination selection information of a downstream frame are managed for each LLID, and necessary information is registered in the MAC address search table 27.

Next, an operation of deciding the output destination of an upstream frame by the frame transfer processing unit 20 will be explained.

When an upstream frame received by the PON port 11 is not a PON control frame, the frame transfer processing unit 20 decides, in the following way, to which of the carrier networks NW the received upstream frame should be output.

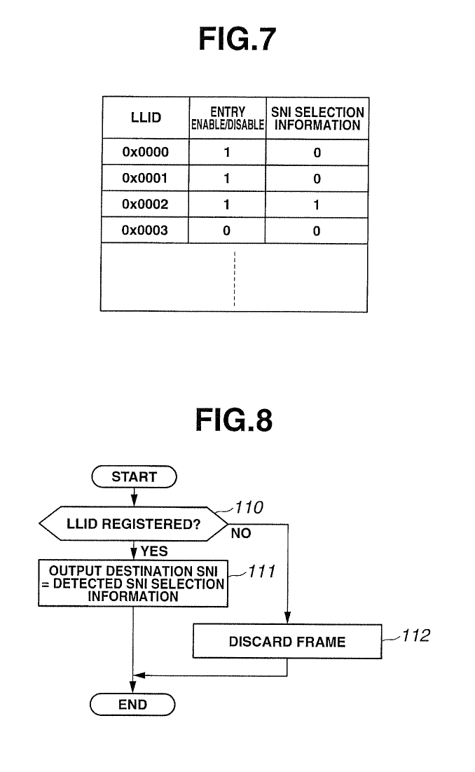

The frame transfer processing unit 20 includes the LLID table 23 as shown in FIG. 7. Entry enable/disable and SNI selection information are registered in the LLID table 23 for the LLID of each ONU. Entry enable/disable is information representing the enable/disable state of the entry, that is, registration/non-registration of the LLID.

The output destination SNI determination unit 22 reads out SNI selection information from the LLID table 23 based on the LLID of an upstream frame, decides an output destination SNI according to a procedure in FIG. 8, and embeds the SNI selection information to the upstream output destination directing unit 24.

In the upstream frame output destination SNI decision procedure shown in FIG. 8, the output destination SNI determination unit 22 first confirms, based on the entry enable/disable of the LLID of a received upstream frame in the LLID table 23, whether the LLID has been registered in the LLID table 23 (step 110).

If the “enable” state has been set as the entry enable/disable, that is, the LLID has been registered (step 110: YES), the output destination SNI determination unit 22 reads out SNI selection information corresponding to the LLID from the LLID table 23, specifies it as the output destination of a downstream frame (step 111), and ends the series of processes.

If the “disable” state has been set as the entry enable/disable, that is, the LLID of the received upstream frame has not been registered in the LLID table 23 (step 110: NO), the output destination SNI determination unit 22 decides to discard the upstream frame (step 112), and ends the series of processes.

In parallel to the upstream frame output destination SNI decision procedure, the upstream latency compensation unit 21 adds a delays to the received upstream frame to compensate the latency generated by output destination SNI decision processing in the output destination SNI determination unit 22.

The upstream output destination directing unit 24 transfers the upstream frame from the upstream latency compensation unit 21 to the corresponding upstream output timing adjustment unit 25A or 25B in accordance with the SNI selection information decided by the output destination SNI determination unit 22.

The upstream output timing adjustment units 25A and 25B are provided for the transmission/reception circuits 18A and 18B. The upstream output timing adjustment units 25A and 25B adjust the output order of upstream frames based on priority determined by PCP included in the upstream frames or the like, and transfer the upstream frames from the upstream output destination directing unit 24 to the corresponding transmission/reception circuits 18A and 18B.

If the output destination SNI determination unit 22 notifies to discard the frame, the upstream output destination directing unit 24 discards the upstream frame.

At the time of ONU registration by the control frame processing unit 14, values in the LLID table 23 are set by determining, by external hardware or software (not shown in FIG. 3), which of the networks NW1 and NW2 (in FIG. 3, carrier NW (0 system) and carrier NW (1 system)) should be connected. For example, when one SNI is for 10 G-Ethernet and the other is for 1 G-Ethernet in a system in which a 10 G-ONU and a 1 G-ONU coexist, the 10 G-Ethernet SNI can be designated for the 10 G-ONU and the 1 G-Ethernet SNI can be designated for the 1 G-ONU.

Note that in downstream processing, frames input from the two transmission/reception circuits 18A and 18B need to be processed parallel. However, by performing parallel processes between the systems, as in the arrangement of FIG. 4, the throughput of the frame input to each SNI can be used maximally. At this time, when the 10 G output complies with 802.3av specifications, the upper limit of the throughput is about 8.7 Gbps, so the upper limit of the throughput of an SNI input for this 10 G output is about 8.7 Gbps.

In the frame transfer processing unit 20, portions belonging to the constantly fed block B0 and portions belonging to the power saving block B1 coexist.

Of these portions, the LLID table 23, the upstream output timing adjustment unit (0 system) 25A, the upstream output timing adjustment unit (1 system) 25B, the MAC address search table 27, the downstream latency compensation unit (0 system) 31A, the downstream latency compensation unit (1 system) 31B, the LLID embedding unit (0 system) 32A, the LLID embedding unit (1 system) 32B, the downstream output destination directing unit (0 system) 33A, the downstream output destination directing unit (1 system) 33B, the downstream output destination determination unit (0 system) 34A, the downstream output destination determination unit (1 system) 34B, a VID table 35, the downstream output timing adjustment unit (0 system) 36A, and the downstream output timing adjustment unit (1 system) 36B belong to the constantly fed block B0.

The upstream latency compensation unit 21, the output destination SNI determination unit 22, the upstream output destination directing unit 24, and the MAC address registration unit 26 belong to the power saving block B1.

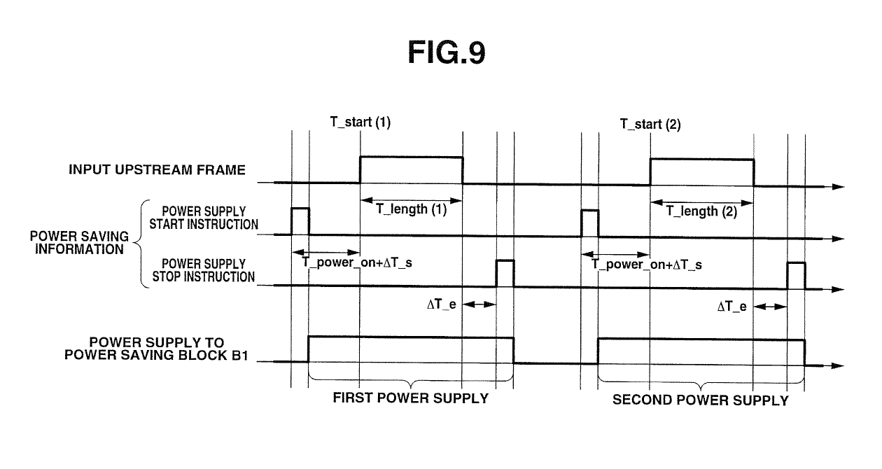

Next, power supply stop/start processing to the power saving block B1 will be explained in detail with reference to FIG. 9. FIG. 9 is a timing chart showing the stop/start of power supply to the power saving block B1 according to the first embodiment. The bandwidth allocation processing unit 15 calculates upstream bandwidth allocation information (upstream frame reception start time T_start and reception period T_length). The upstream bandwidth allocation information can be calculated using a known calculation method such as a method described in non-patent literature 3.

When restarting power supply to the power saving block B1, the bandwidth allocation processing unit 15 transmits a power supply start instruction (pulse signal) to the power supply control unit 40 a predetermined time before the upstream frame reception start time, that is, at time (T_start−T_power_on−ΔT_s) in consideration of a time T_power_on taken to activate the power saving block and a margin ΔT_s.

The time T_power_on taken to activate the power saving block depends on the gate scale of the block and the parameter setting amount and is, e.g., several μsec to several ten μsec. The margin ΔT_s depends on the fluctuation width of the arrival time of a presumed frame and is, e.g., several ten nsec to several hundred nsec. In IEEE EPON, T_start is, e.g., the time before RTT correction of the transmission start time stored in a GATE frame to be transmitted from the OLT to the GNU. In ITU-T NGPON, T_start is, e.g., the time before RTT correction of a transmission start slot indicated in the upstream bandwidth map (US BWmap) field of the physical control block downstream (PCBd: downstream physical control block) of a GTC header.

When stopping power supply to the power saving block B1, the bandwidth allocation processing unit 15 transmits a power supply stop instruction (pulse signal) to the power supply control unit 40 a predetermined time after the upstream frame reception completion time, that is, at time (T_start+T_length+ΔT_e) in consideration of a margin ΔT_e. The time equivalent to the timing (T_start+T_length) when sending a power supply stop instruction is, e.g., <start time>+<length>before RTT correction in IEEE EPON, and is, e.g., <stop slot>before RTT correction in ITU_T NGPON. The margin ΔT_e depends on the fluctuation width of the arrival time of a presumed frame and is, e.g., several ten nsec to several hundred nsec. Note that the power supply stop instruction (pulse signal) is, e.g., a 1-bit pulse signal. As shown in the flowchart of FIG. 9, the power supply start instruction and the power supply stop instruction are different signals (separate wiring lines).

When the bandwidth allocation processing unit 15 transmits the power supply start instruction to the power supply control unit 40, the power switch 41 is closed in accordance with the control signal S1 to supply power to the power saving block B1. When the bandwidth allocation processing unit 15 transmits the power supply stop instruction to the power supply control unit 40, the power switch 41 is opened in accordance with the control signal S1 to stop the power supply to the power saving block B1.

### Effects of First Embodiment

As described above, according to this embodiment, the power supply control unit 40 constantly supplies power to circuit units belonging to the constantly fed block B0, out of one constantly fed block B0 and one power saving block B1 provided by dividing in advance circuit units constituting the OLT 10. As for circuit units belonging to the power saving block B1, the power supply control unit 40 starts power supply to the power saving block in synchronism with the start of the period of an upstream bandwidth allocated to the ONU, and stops the power supply to the power saving block in synchronism with the end of the period of the upstream bandwidth.

More specifically, the power supply control unit 40 starts power supply to the power saving block B1 a predetermined time before the upstream frame reception start time (upstream bandwidth start timing) based on upstream bandwidth allocation information allocated in advance to each ONU by the bandwidth allocation processing unit 15. The power supply control unit 40 stops the power supply to the power saving block B1 a predetermined time after the upstream frame reception completion time (upstream bandwidth end timing).

Since power is supplied to the power saving block in synchronism with the period of an upstream bandwidth allocated to each ONU, the power supply to the power saving block is stopped in the remaining period. When there is an unused upstream bandwidth, power supply to circuits concerning reception of an upstream frame can be stopped in the period of the unused bandwidth. This can reduce the power consumption in the circuit units concerning reception of an upstream frame in a period in which no upstream frame is received, and can reduce the power consumption of the overall OLT 10.

At this time, the power saving block B1 may include at least the reception circuit 12 or/and the frame demultiplexing unit 13.

The power saving block B1 may include one or more circuit units (equivalent to a frame transfer power saving block to be described later) that are provided in the frame transfer processing unit 20 and are used in transfer processing for transferring upstream frames received by the reception circuit 12 to the transmission/reception circuits 18A and 18B corresponding to the upstream frames. More specifically, the power saving block B1 may include one or more, or all of the upstream latency compensation unit 21, the output destination SNI determination unit 22, the upstream output destination directing unit 24, and the MAC address registration unit 26.

Similarly, power supply to an upstream frame reception circuit (not shown) in the PON port 11 can be stopped.

This embodiment has exemplified a case in which, based on the amount of upstream data waiting for transmission in an ONU that is notified from the ONU by a REPORT frame, the period of an upstream bandwidth used to transmit an upstream frame from each ONU is used as the period of an upstream bandwidth for controlling power supply to the power saving block B1. However, the period of the upstream bandwidth is not limited to this. Another example of the upstream bandwidth allocated to an ONU from the OLT 10 is an upstream bandwidth used to transmit a upstream control frame from an ONU, such as a Discovery Window period (to be described later), in addition to the above-described bandwidth for transmitting upstream data.

In this embodiment, as the period of an upstream bandwidth in which power supply to the power saving block B1 is controlled, for example, the period of an upstream bandwidth used to transmit an upstream frame from each ONU, and the period of an upstream bandwidth used to transmit a upstream control frame from each ONU are used based on the amount of upstream data waiting for transmission in an ONU that is notified from the ONU. Therefore, the power consumption of the overall OLT 10 can be reduced finely.

In this embodiment, the activation control unit 48 has a function of outputting an instruction signal to the power supply control unit 40 to activate circuit units according to a predetermined procedure when restarting power supply to the power saving block B1, power supply to which has been stopped, and some reception circuits in the PON port 11.

In general, the circuit units are activated in order from the frame transmission source side to the frame transmission destination side along a path through which a frame passes. For example, when settings can be changed according to the following procedure, the same expected normal operation as that before the stop of power supply becomes possible.

The activation control unit 48 monitors output signals such as a frame output from respective circuit units, checks the presence/absence and normality of the output signals, confirms whether the circuit units have been activated normally in response to power-on, and activates the circuit units in an order in which a frame flows. This activation processing starts a predetermined time before the upstream frame reception start time, for example, at the time obtained by subtracting, from the frame head arrival time considering an error, a time necessary to activate the power saving block B1 so that the activation becomes ready in time for the arrival of a frame.

Procedure 1: Based on power saving information serving as a trigger, the activation control unit 48 and the power supply control unit 40 cooperate with each other to supply power to an upstream signal reception circuit (not shown), power supply to which has been stopped in the PON port 11.

Procedure 2: It is confirmed whether the upstream signal reception circuit, power supply to which has been stopped in the PON port 11, is normally activated and frames can be transmitted/received between ONUs.

The confirmation is performed by, for example, receiving an activation completion notification from each circuit by the activation control unit 48 or the power supply control unit 40, or waiting for only the time (determined by the circuit configuration of each circuit) taken for activation after power-on.

Procedure 3: The reception circuit 12 is turned on.

Procedure 4: It is confirmed whether the reception circuit 12 has been activated normally.

Procedure 5: The frame demultiplexing unit 13 is turned on.

Procedure 6: It is confirmed whether the frame demultiplexing unit 13 has been activated normally.

Accordingly, the circuit units can be activated in order from the frame transmission source side to the frame transmission destination side along a path through which a frame passes. Even when feeding again power to the power saving block B1, power feeding to which has been stopped, the circuit units in the power saving block B1 can stably start operating.

In this embodiment, the LLID and downstream output destination selection information of an ONU are registered in the MAC address search table 27 for the MAC address of each user apparatus connected to an ONU or that of each ONU. When downstream frames are received from host apparatuses, the frame transfer processing unit 20 reads out, from the MAC address search table 27, LLIDs and pieces of downstream output destination selection information corresponding to the destination MAC addresses of the downstream frames parallel for the input SNI ports 19A and 19B.

When the transmission rate is judged after deciding the destination LLID of a downstream frame, as in the first prior art described above, a circuit that reads out a table configured to manage the downstream transmission rate of each LLID becomes necessary in addition to the MAC address search table 27, increasing the circuit scale of the OLT.

According to this embodiment, the destination LLID and downstream output destination selection information (downstream transmission rate) of a downstream frame can be specified by only readout from the MAC address search table 27. Thus, the output system of the downstream frame can be specified while hardly increasing the circuit scale of the OLT 10.

In this embodiment, SNI selection information corresponding to an LLID is registered in the LLID table 23 for the LLID of each ONU. When an upstream frame is received from an ONU, the frame transfer processing unit 20 reads out, from the LLID table 23, SNI selection information corresponding to the LLID of the upstream frame.

When the OLT 10 is connected to a plurality of host apparatuses via SNIs provided for the respective host apparatuses, an upstream frame received from an arbitrary ONU connected to the PON system can be transferred to a host apparatus corresponding to the ONU. Downstream frames input via the plurality of SNI ports 19A and 19B can be processed parallel for the respective input SNI ports 19A and 19B, and transferred to destination ONUs.

One OLT 10 having ports for respective SNIs can transfer a frame between each ONU of the PON system, each host apparatus, and each carrier network ahead without a switch interposed between the OLT 10 and the plurality of SNIs. The downstream bandwidth of the switch need not be shared between the host apparatuses, and the restriction on a downstream bandwidth usable in each host apparatus can be removed.

In this embodiment, when one SNI is for 10 G-Ethernet and the other is for 1 G-Ethernet in a system in which a 10 G-ONU and a 1 G-ONU coexist, the 10 G-Ethernet SNI can be used for the 10 G-ONU and the 1 G-Ethernet SNI can be used for the 1 G-ONU.

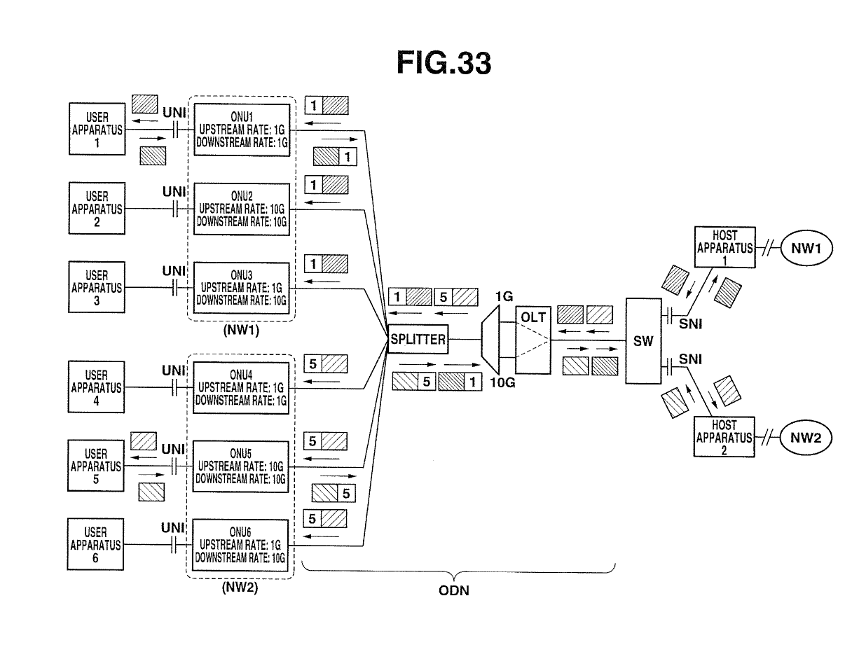

In this case, all frames input from the 10 G-Ethernet SNI out of downstream frames are frames addressed to the 10 G-ONU, and all frames input from the 1 G-Ethernet SNI are frames addressed to the 1 G-ONU. The downstream transfer ability (downstream transmission rate) in the PON section can be used maximally. Thus, the downstream bandwidth need not be shared between two host apparatuses, unlike the conventional arrangement in FIG. 33.

When a downstream output addressed to the 10 G-GNU complies with 802.3av specifications, the upper limit of the downstream throughput in the PON section is about 8.7 Gbps. In this case, the upper limit of the throughput of an SNI input for the 10 G-ONU becomes about 8.7 Gbps, and the downstream bandwidth needs to be restricted in a host apparatus for the 10 G-ONU. However, this bandwidth restriction is similarly imposed even in a case in which only one host apparatus for the 10 G-GNU is connected, and does not deny the effectiveness of the present invention.

When an OLT including only one 10 G-Ethernet SNI is constituted according to the conventional technique, the upper limit of the downstream throughput in the coexistent state of 802.3av specifications and 802.3ah specifications is about 8.7 Gbps, equal in the present invention, 1 Gbps=about 9.7 Gbps. However, the conventional technique requires a switch and the like to connect a plurality of host apparatuses. In this embodiment, if the specifications of a downstream output addressed to the 10 G-ONU are not 802.3av specifications but are changed to specifications capable of a 10-Gbps throughput, the maximum downstream throughput in the coexistent state of the 10 G-ONU and the 1 G-ONU becomes 10 Gbps+1 Gbps=11 Gbps, and the downstream bandwidth need not be restricted in a host apparatus.

When the frame transfer processing unit 20 has the arrangement in FIG. 4, the 10 G-Ethernet SNI can also be used as the 1 G-ONU SNI. In this case, however, a host apparatus needs to restrict the downstream bandwidth to 1 Gbps or lower. To the contrary, the 1 G-Ethernet SNI can also be used as the 10 G-ONU SNI. In this case, the downstream transfer ability in the PON section cannot be used maximally.

This embodiment has exemplified a system in which a 10 G-ONU and a 1 G-ONU coexist, but the present invention is not limited to this. For example, the present invention is also applicable to a case in which ONUs to be accommodated are only 10 G-ONUs, but the respective ONUs are connected to different networks. An OLT in this case suffices to be equipped with a plurality of 10 G-Ethernet SNIs and a plurality of downstream PON outputs equivalent to 802.3av specifications. In this case, the downstream wavelength is changed for each downstream output port, and if necessary, changed for each host network to which a WDM filter in the ONU is connected.

In this embodiment, the MAC address registration unit 26 reads out a transmission source MAC address and LLID from a received upstream frame, and registers the LLID and downstream output destination selection information corresponding to the LLID in the MAC address search table 27 in association with the transmission source MAC address. The MAC address search table 27 can be registered and updated based on a received upstream frame.

### Second Embodiment

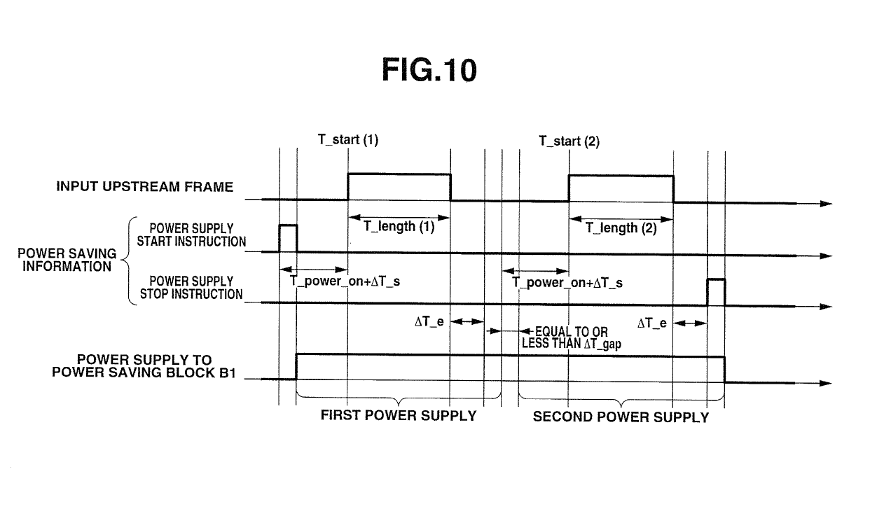

An OLT 10 according to the second embodiment of the present invention will be described next with reference to FIG. 10.

As shown in FIG. 10, in this embodiment, when the difference between the first power supply stop time (T_start(1)+T_length(1)+ΔT_e) and the subsequent second power supply start time (T_start(2)−T_power_on−ΔT_s) is equal to or smaller than a predetermined time (ΔT_gap in the example of FIG. 10), a bandwidth allocation processing unit 15 sends neither a power supply stop instruction nor a power supply start instruction to a power supply control unit 40 at an interval between the first power supply and the second power supply.

### Effects of Second Embodiment

As described above, according to this embodiment, when the power feeding interval is small, the OLT 10 can be operated normally to transfer an upstream frame without losing a frame.

### Third Embodiment

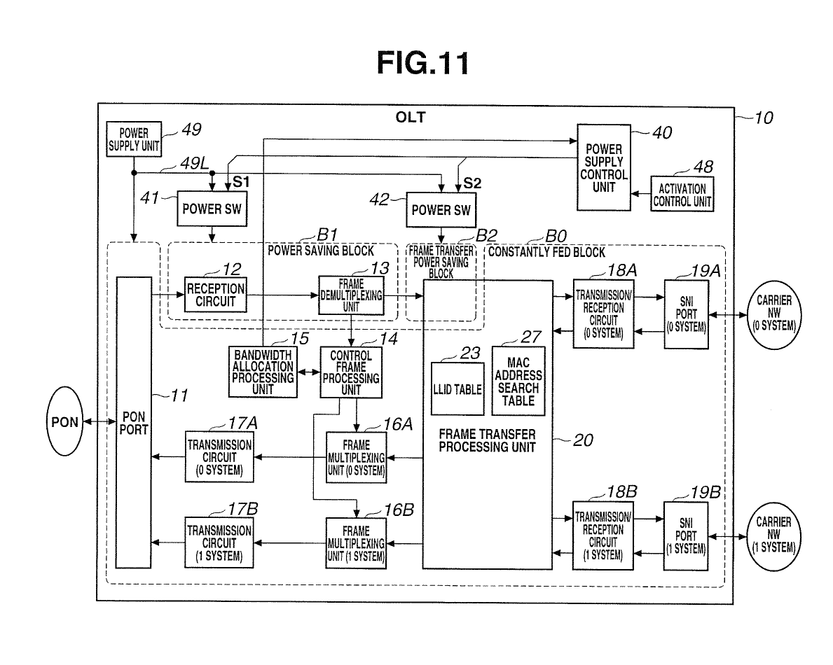

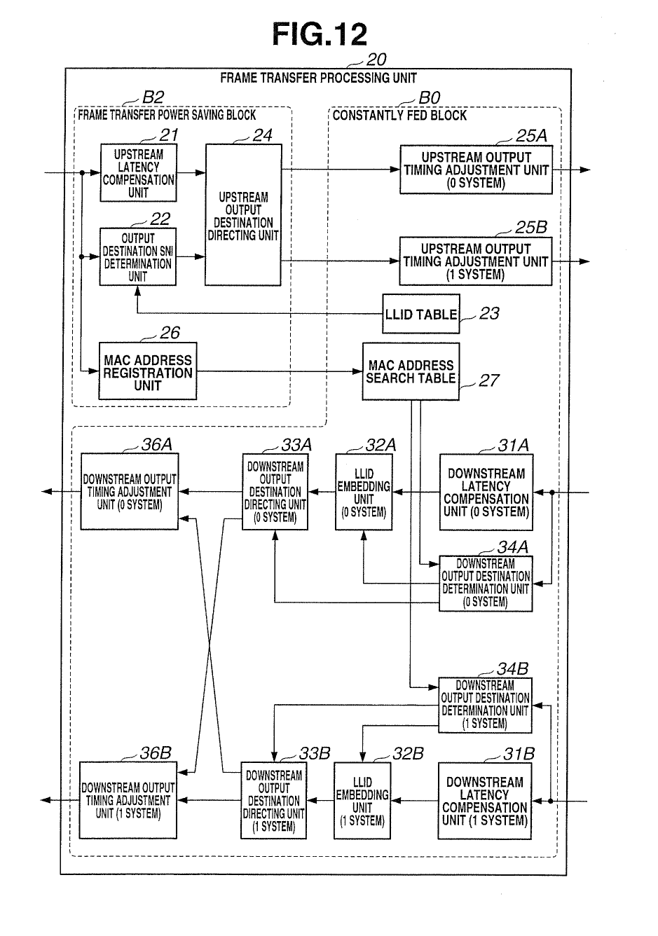

An OLT 10 according to the third embodiment of the present invention will be described next with reference to FIGS. 11 and 12.

As shown in FIG. 11, the OLT 10 according to this embodiment is different from the OLT 10 in FIG. 3 (first embodiment) in that the power saving block is divided into a power saving block B1 and a frame transfer power saving block B2. A reception circuit 12 and a frame demultiplexing unit 13 belong to the power saving block B1. Some of circuits concerning reception of an upstream frame in a frame transfer processing unit 20 belong to the frame transfer power saving block B2.

As shown in FIG. 12, the frame transfer processing unit according to this embodiment is different from the frame transfer processing unit in FIG. 4 (first embodiment) in that the part of the “power saving block B1” is changed into the “frame transfer power saving block B2”.

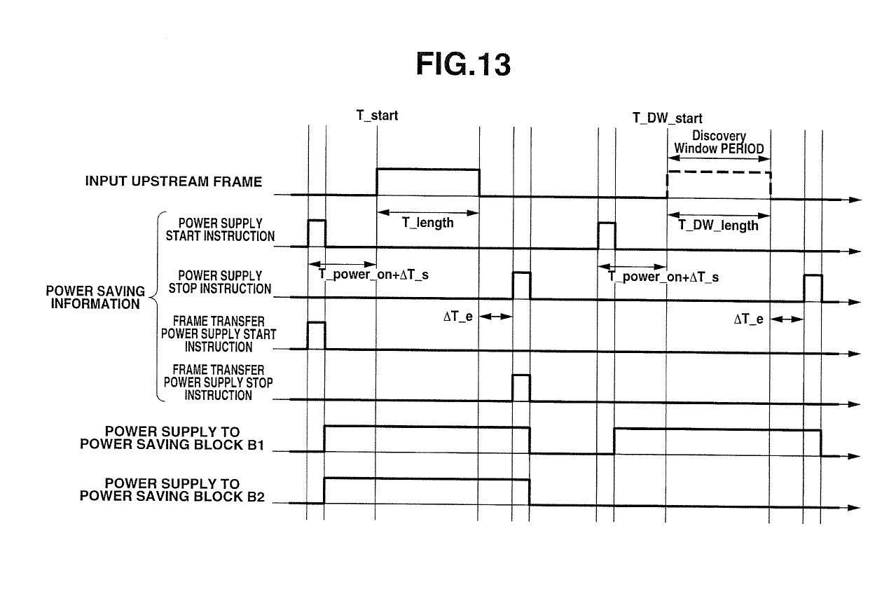

Next, power supply stop/start processing to the power saving block B1 and the frame transfer power saving block B2 will be explained in detail with reference to FIG. 13.

As shown in FIG. 13, a bandwidth allocation processing unit 15 transmits a power supply start instruction (pulse signal) and a power supply stop instruction (pulse signal) to a power supply control unit 40 at the same timings as those in the first embodiment for the power saving block B1.

Further, the bandwidth allocation processing unit 15 calculates Discovery Window information (Discovery Window start time T_DW_start and Discovery Window length T_DW_length). The Discovery Window is a period for which the OLT 10 waits for an LLID registration request from an ONU. Upstream input frames are a user frame, a control frame, and the like. The upstream user frame is output to a carrier NW via a PON port 11→the reception circuit 12→the frame demultiplexing unit 13→the frame transfer processing unit 20→a transmission/reception circuit 18→an SNI port 19. The control frame and the like are transferred via the path of the PON port 11→the reception circuit 12→the frame demultiplexing unit 13→a control frame processing unit 14, and are used for PON control. An LLID registration request frame is a frame addressed to the OLT 10 (control frame used for PON control). Thus, the LLID registration request frame is transferred from the frame demultiplexing unit 13 to the control frame processing unit 14, and is not transferred to the frame transfer processing unit 20.

In the Discovery Window period, power supply to the frame transfer processing unit 20 can be stopped. More specifically, before and after a period in which an upstream bandwidth is allocated, the bandwidth allocation processing unit 15 transmits a power supply start instruction, a power supply stop instruction, a frame transfer power supply start instruction, and a frame transfer power supply stop instruction (pulse signals) to the power supply control unit 40 to restart/stop power supply to the power saving block B1 and the frame transfer power saving block B2. Before and after the Discovery Window period, the bandwidth allocation processing unit 15 transmits only a power supply start instruction and a power supply stop instruction (pulse signals) to the power supply control unit 40, and transmits neither a frame transfer power supply start instruction nor a frame transfer power supply stop instruction (pulse signals).

When the bandwidth allocation processing unit 15 transmits the power supply start instruction to the power supply control unit 40, a power switch 41 is closed in accordance with a control signal S1 to supply power to the power saving block B1. When the bandwidth allocation processing unit 15 transmits the power supply stop instruction to the power supply control unit 40, the power switch 41 is opened in accordance with the control signal S1 to stop the power supply to the power saving block B1.

When the bandwidth allocation processing unit 15 transmits the frame transfer power supply start instruction to the power supply control unit 40, a power switch 42 is closed in accordance with a control signal S2 to supply power to the frame transfer power saving block B2. When the bandwidth allocation processing unit 15 transmits the frame transfer power supply stop instruction to the power supply control unit 40, the power switch 42 is opened in accordance with the control signal S2 to stop the power supply to the frame transfer power saving block B2.

### Effects of Third Embodiment

As described above, this embodiment further employs the frame transfer power saving block B2 including one or more circuit units that are provided in the frame transfer processing unit 20 and used in transfer processing for transferring upstream frames received by the reception circuit 12 to transmission/reception circuits 18A and 18B corresponding to the upstream frames. In addition to the above-mentioned power supply synchronized with an upstream bandwidth allocated to each ONU, the power supply control unit 40 starts power supply to the power saving block B1 in synchronism with the start of the Discovery Window period for waiting for an LLID registration request notified from an ONU, and stops the power supply in synchronism with the end of the Discovery Window period. The power supply control unit 40 starts power supply to the frame transfer power saving block B2 in synchronism with the start of the period of the upstream bandwidth, and stops the power supply in synchronism with the end of the period of the upstream bandwidth. In the Discovery Window period, the power supply control unit 40 stops the power supply to the frame transfer power saving block B2.

This embodiment can reduce the power consumption in part of the frame transfer processing unit 20, i.e., the frame transfer power saving block B2 that is not used in the Discovery Window period, and can reduce the power consumption of the overall OLT 10.

As for the power saving block B1, the supply and stop of power are controlled in synchronism with the start and end timings of the Discovery Window period similarly to the start and end timings of an upstream bandwidth. Power is supplied to the reception circuit 12 and frame demultiplexing unit 13 in the power saving block B1 that are used in the Discovery Window period, and an LLID registration request notified from an GNU can be received normally.

### Fourth Embodiment

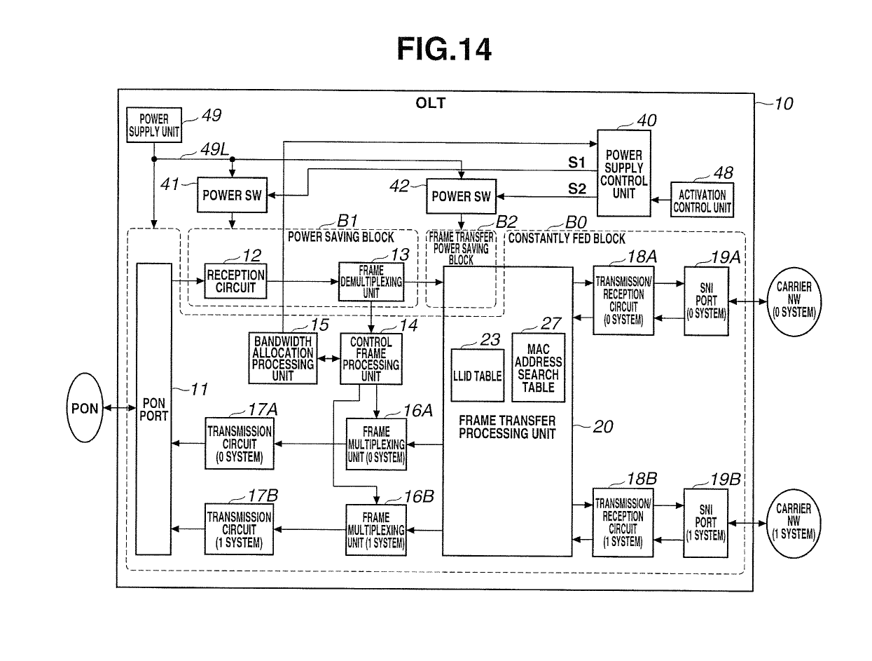

An OLT 10 according to the fourth embodiment of the present invention will be explained next with reference to FIG. 14.

As shown in FIG. 14, the OLT 10 according to this embodiment is different from those in the first to third embodiments in that an upstream input unit 12A is added.

In this embodiment, in addition to the functions described in the first embodiment, a bandwidth allocation processing unit 15 has a function of reading out downstream output destination selection information corresponding to the LLID of a scheduled upstream frame from PON-IF port information registered in advance in the bandwidth allocation processing unit 15 in synchronism with the timing of an upstream frame allocated in advance by the bandwidth allocation processing unit 15, and instructing the upstream input unit 12A about the downstream output destination selection information.

The upstream input unit 12A is a processing unit that embeds the downstream output destination selection information instructed by the bandwidth allocation processing unit 15 into the preamble of an upstream frame.

A MAC address registration unit 26 (see FIG. 4) has a function of acquiring a transmission source MAC address, an LLID, and downstream output destination selection information from an upstream frame transferred from the upstream input unit 12A, and registering the LLID and the downstream output destination selection information in a MAC address search table 27 in association with the transmission source MAC address.

The remaining arrangement according to this embodiment is the same as that in the first embodiment, and a detailed description thereof will not be repeated.

### Operation of Fourth Embodiment

The bandwidth allocation processing unit 15 reads out downstream output destination selection information corresponding to the LLID of a scheduled upstream frame from PON-IF port information in synchronism with the reception timing of the upstream frame allocated in advance, and instructs the upstream input unit 12A about the downstream output destination selection information. As the downstream output destination selection information, for example, downstream output destination selection information of an ONU is read out from a control frame notified from the ONU at the start of communication.

At this time, when the LLID of the upstream frame is allocated to a 1 G-ONU (the upstream rate is 1 G and the downstream rate is 1 G), the upstream input unit 12A is instructed about the “0 system” as the downstream output destination selection information. When the LLID of the upstream frame is allocated to a 10 G-ONU (the upstream rate is 10 G and the downstream rate is 10 G), the upstream input unit 12A is instructed about the “1 system” as the downstream output destination selection information. When the LLID of the upstream frame is allocated to an asymmetrical GNU (the upstream rate is 1 G and the downstream rate is 10 G), the upstream input unit 12A is instructed about the “1 system” as the downstream output destination selection information.

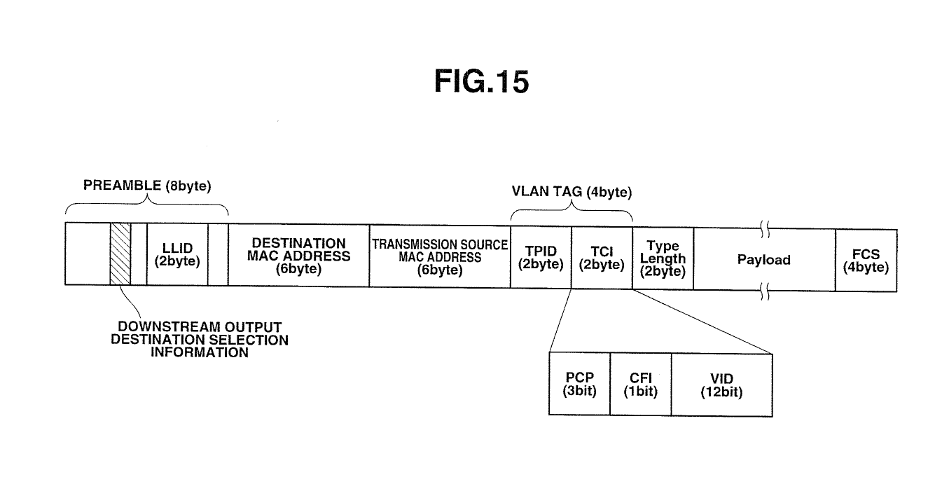

The upstream input unit 12A embeds the downstream output destination selection information instructed by the bandwidth allocation processing unit 15 into the preamble of the upstream frame. As shown in FIG. 15, the upstream frame output from the upstream input unit according to this embodiment is different from a frame transmitted in the PON section shown in FIG. 2 described above in that downstream output destination selection information is embedded in the preamble.

For example, when the instruction from the bandwidth allocation processing unit 15 is the “0 system”, the upstream input unit 12A embeds “0” into downstream output destination selection information of the preamble of an upstream frame. When the instruction from the bandwidth allocation processing unit 15 is the “1 system”, the upstream input unit 12A embeds “1” into downstream output destination selection information of the preamble of an upstream frame.

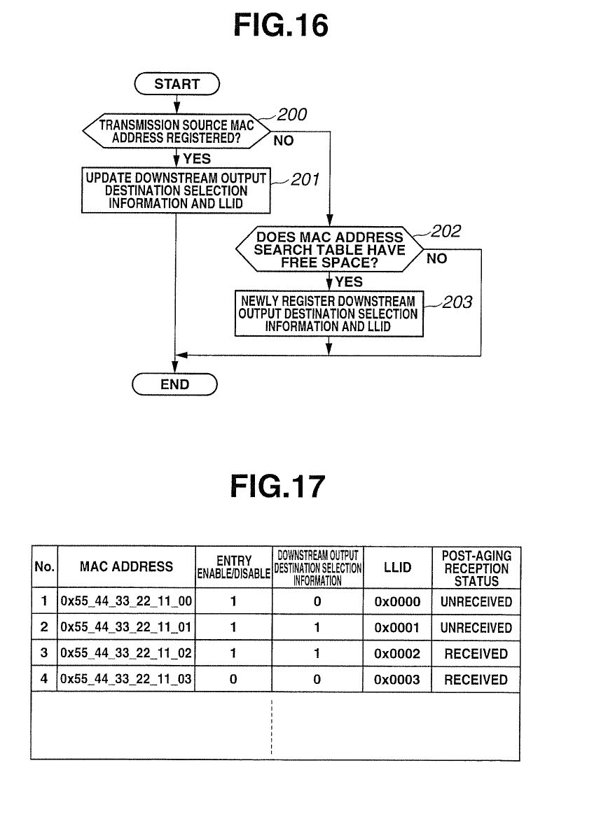

In the arrangement of the OLT 10 according to this embodiment, values in the MAC address search table 27 of the frame transfer processing unit 20 can be automatically set upon receiving an upstream frame. A method of automatically registering the transmission source MAC address and output destination selection information of a received upstream frame by the frame transfer processing unit 20 will be explained with reference to FIG. 16.

If a received upstream frame is not a PON control frame, the MAC address registration unit 26 performs MAC address registration processing in FIG. 16 based on the transmission source MAC address of the upstream frame.

The MAC address registration unit 26 first searches the MAC address search table 27 based on the transmission source MAC address of the upstream frame (step 200). If the transmission source MAC address has already been registered in the MAC address search table (step 200: YES), the MAC address registration unit 26 updates the downstream output destination selection information and LLID corresponding to the MAC address (step 201), and ends the series of processes. Note that execution of step 201 may be skipped not to update the information.

The downstream output destination selection information to be registered in the MAC address search table 27 is downstream output destination selection information which has been embedded in the preamble of an upstream frame by the upstream input unit 12A, as shown in FIG. 15, and read out by the MAC address registration unit 26. The LLID is an LLID which has been embedded in advance in the preamble of the upstream frame and read out by the MAC address registration unit 26.

If the MAC address has not been registered in the MAC address search table 27 (step 200: NO), the MAC address registration unit 26 confirms whether a free area exists in the MAC address search table 27 (step 202). “A free area exists” indicates that there is an entry in which the “disable” state is set as entry enable/disable.

If a free area exists (step 202: YES), the MAC address registration unit 26 registers the downstream output destination selection information and the LLID in the free entry in association with the MAC address (step 203), and ends the series of processes. If no free area exists (step 202: NO), the MAC address registration unit 26 ends the series of processes.

### Effects of Fourth Embodiment

As described above, according to this embodiment, the upstream input unit 12A gives, to an upstream frame, downstream output destination selection information concerning the transmission source ONU of the received upstream frame. The MAC address registration unit 26 reads out the transmission source MAC address, the LLID, and the downstream output destination selection information from the upstream frame transferred from the upstream input unit 12A. The MAC address registration unit 26 registers the LLID and the downstream output destination selection information in the MAC address search table 27 in association with the transmission source MAC address.

The MAC address registration unit 26 can automatically register the MAC address, the LLID, and the downstream output destination selection information in the MAC address search table 27, including those of an asymmetric ONU (the upstream rate is 1 G, and the downstream rate is 10 G).

The MAC address registration unit 26 is notified of the downstream output destination selection information using the upstream frame. Similarly to the transmission source MAC address and LLID to be registered in the MAC address search table 27, the MAC address registration unit 26 can read out the downstream output destination selection information at the same timing. A circuit or control to read out the downstream output destination selection information in synchronism with the transmission source MAC address and the LLID need not be added. The downstream output destination selection information can be notified with a very simple arrangement.

Note that the arrangement according to this embodiment is different from the arrangement according to the first embodiment in that the upstream input unit 12A needs to be added to embed downstream output destination selection information in upstream processing. In this case, downstream output destination selection information can easily be embedded into the preamble of an upstream frame by obtaining the downstream output destination selection information (corresponding to the downstream transmission rate of a control frame called a Gate frame) from the bandwidth allocation processing unit 15 that performs upstream bandwidth allocation.

As in the arrangements according to the first to third embodiments, power supply to a power saving block B2 can be stopped in accordance with the upstream bandwidth allocation and the Discovery Window period, and power of the OLT 10 can be saved.

### Fifth Embodiment

An OLT 10 according to the fifth embodiment of the present invention will be described next.

In this embodiment, a MAC address registration unit 26 of the OLT 10 adds an (aging processing) means for confirming the reception history of registered MAC addresses in a predetermined cycle and disabling, in a MAC address search table 27, registered MAC addresses having no reception history in a predetermined period. The cycle of aging processing will be referred to as an “aging cycle”, and a timer to count the aging cycle will be referred to as an “aging timer”.

As shown in FIG. 17, an item “post-aging reception status” is added to the MAC address search table according to this embodiment, unlike FIG. 5 described above. The “post-aging reception status” is information representing whether a frame of a target MAC address has been received by the current point of time after previous aging processing.

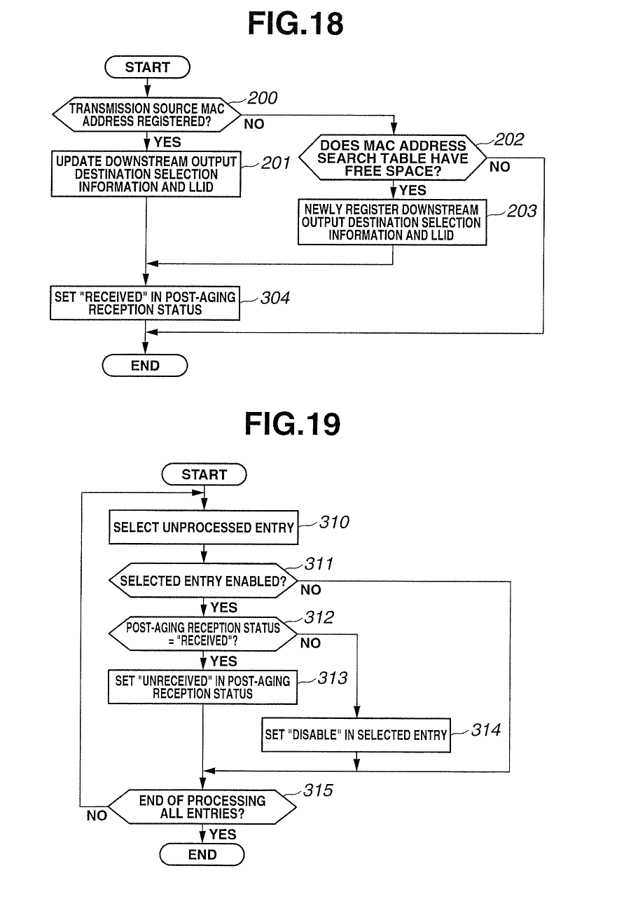

As shown in FIG. 18, in a MAC address registration procedure according to this embodiment, a post-aging reception status corresponding to a target MAC address is set to be “received” at the end of the MAC address registration procedure shown in FIG. 16 described above (step 304). The post-aging reception status becomes “received” every time a MAC address is newly registered or the registration is updated.

The MAC address registration unit 26 executes the aging processing procedure shown in FIG. 19 in every predetermined cycle.

The MAC address registration unit 26 first selects one unprocessed entry from the MAC address search table 27 (step 310), and confirms whether the entry of the selected entry has been set in the “enable” state (step 311). If the selected entry is in the “enable” state (step 311: YES), the MAC address registration unit 26 confirms whether the post-aging reception status of the selected entry has been set to be “received” (step 312).

If the post-aging reception status has been set to be “received” (step 312: YES), the MAC address registration unit 26 sets the post-aging reception status of the selected entry to be “unreceived” (step 313), and confirms whether all entries have been processed (step 315). If an unprocessed entry remains (step 315: NO), the process returns to step 310. If all entries have been processed (step 315: YES), the MAC address registration unit 26 ends the series of processes.

If the post-aging reception status of the selected entry has been set to be “unreceived” (step 312: NO), the MAC address registration unit 26 sets the entry of the selected entry to be the “disable” state representing that this entry is not used (step 314), and advances to step 315.

If the entry of the selected entry is in the “disable state” in step 311 as well (step 311: NO), the process advances to step 315.

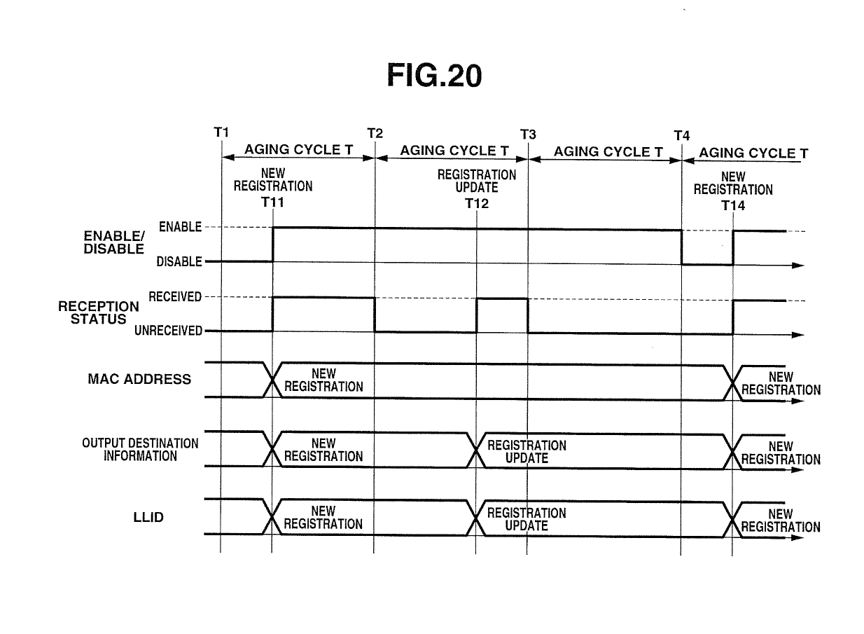

Transition of an entry in the MAC address search table according to this embodiment will be explained with reference to FIG. 20.

When the OLT 10 receives an upstream frame having an unregistered transmission source MAC address at time T11 in an aging cycle T from time T1 to time T2, the transmission source MAC address is newly registered in a free entry. This entry is set to be the “enable” state and “received” and then to be “unreceived” by the next aging processing at time T2.

When the OLT 10 receives an upstream frame having this transmission source MAC address again at time T12 in the aging cycle T from time T2 to time T3, the registration of the same MAC address is updated in the entry. The entry is set to be the “enable” state and “received” and then to be “unreceived” by the next aging processing at time T3.

After the entry is set to be the “enable” state and “unreceived” in this manner, if a frame having this transmission source MAC address is not received in the aging cycle T from time T3 to time T4, this entry is set to be the “disable” state by the next aging processing at time T4.

Even if the entry is set to be “unreceived” by the aging processing at time T2 and time T3, it remains in the “enable” state. This transmission source MAC address is continuously registered in the MAC address search table 27 till time T4, and set to be the “disable” state at time T4. Setting the entry to be the “disable” state means that the MAC address is deleted from the MAC address search table 27, and the entry becomes free (the MAC address is regarded as deleted from the table when the entry is disabled).

Another MAC address can be newly registered in a storage area where the entry is set to be the disable state.

### Effects of Fifth Embodiment

As described above, according to this embodiment, the MAC address registration unit 26 registers a reception status concerning the transmission source MAC address of the upstream frame in the MAC address search table 27 for each received upstream frame. The MAC address registration unit 26 checks the reception statuses of MAC addresses registered in the MAC address search table 27. Among these MAC addresses, the MAC address registration unit 26 sets a MAC address, reception of which has not been confirmed in a predetermined period, to be the disable state.

After a frame having a given transmission source MAC address is received, if no other frame having the same transmission source MAC address is received until the aging processing is performed twice, the transmission source MAC address is set to be the disable state. Since another MAC address can be newly registered in the storage area where the registered information is disabled, the MAC address search table 27 having a limited size (entries) can be used effectively.

For example, 248 entries are necessary to prepare entries for all possible values of a 48-bit MAC address. The MAC address search table 27 becomes very large, and the circuit scale increases, too. The increase in circuit scale can be suppressed by preparing the small-scale MAC address search table 27, deleting MAC addresses in disuse from the MAC address search table 27, and storing a newly registered MAC address in a free entry. In this method of searching for a free entry and storing a newly registered MAC address, MAC addresses are registered while being arranged unevenly.

As in the arrangements according to the first to third embodiments, power supply to a power saving block B2 can be stopped in accordance with the upstream bandwidth allocation and the Discovery Window period, and power of the OLT 10 can be saved.

### Sixth Embodiment

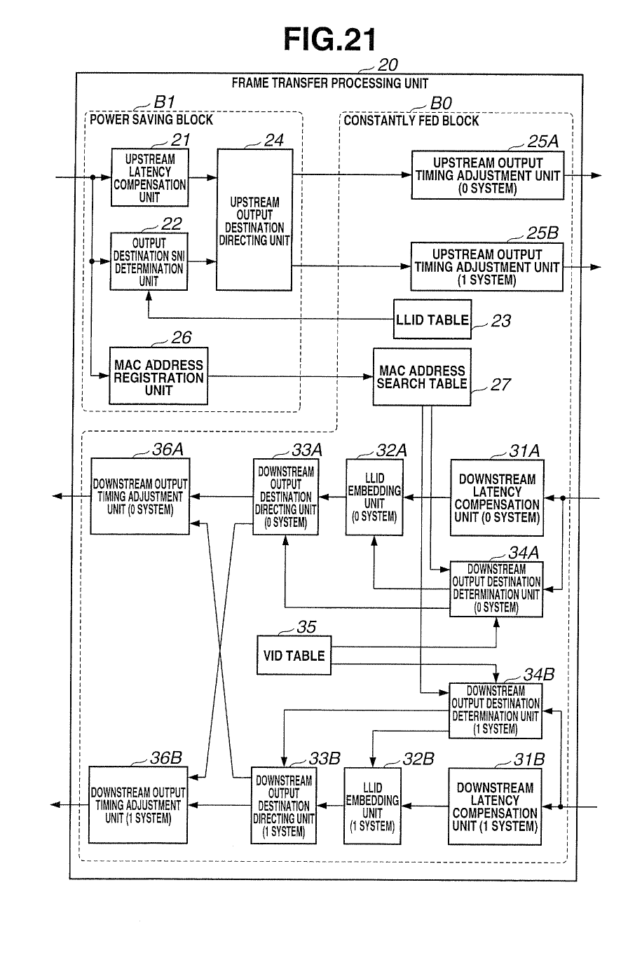

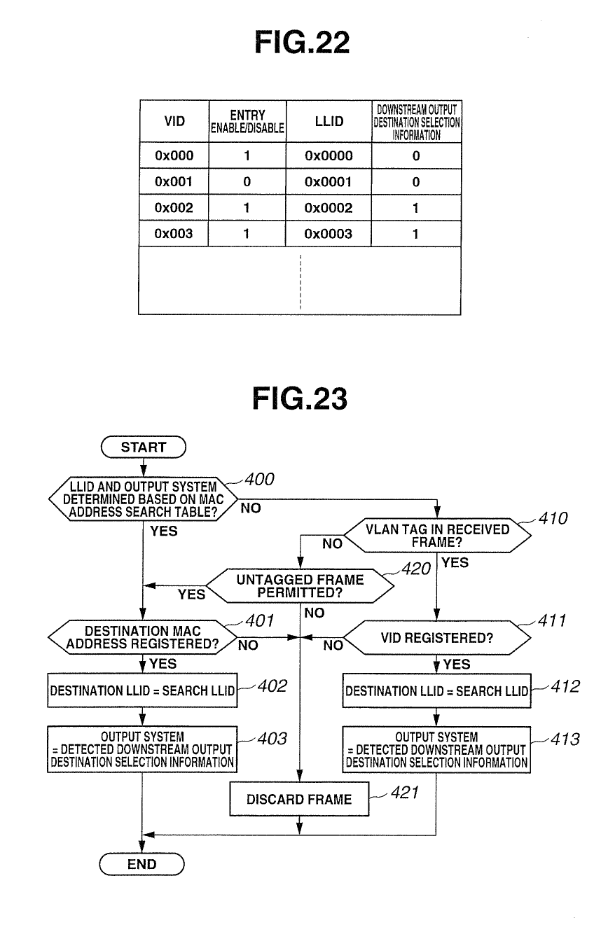

An OLT 10 according to the sixth embodiment of the present invention will be described next with reference to FIGS. 21 and 22.

As shown in FIG. 21, a VID table 35 is added to a frame transfer processing unit 20 according to this embodiment, unlike the first embodiment.

In this embodiment, the frame transfer processing unit 20 decides, based on the registration contents of a MAC address search table 27 or the VID table 35, which of transmission circuits 17A and 17B should transmit a received downstream frame, that is, to which of downstream systems of different rates a received downstream frame should be output. An operation of deciding the output destination of a downstream frame by the frame transfer processing unit 20 will be explained.

Downstream output destination determination units 34A and 34B perform frame transfer processing based on the destination MAC address or VID of a received downstream frame. As shown in FIG. 5 described above, downstream output destination selection information and an LLID are registered in the MAC address search table 27 for each MAC address. As shown in FIG. 22, an LLID and downstream output destination selection information are registered in advance in the VID table 35 for each VID. The VID (VLAN Identifier) is a value designating a VLAN to which the downstream frame belongs.

The downstream output destination determination units 34A and 34B read out LLIDs and pieces of downstream output destination selection information, and decide the LLIDs and output destinations by the following method A or method B:

Method A: An LLID and downstream output destination selection information are read out from the MAC address search table 27 based on the destination MAC address of a received downstream frame.

Method B: An LLID and downstream output destination selection information are read out from the VID table 35 based on the VID of a received downstream frame.

The pieces of decided LLID information are supplied as the destination LLIDs of downstream frames to LLID embedding units 32A and 32B. The pieces of decided output destination information are given as pieces of downstream output destination information to downstream output destination directing units 33A and 33B.

Next, a downstream frame output destination decision procedure will be explained with reference to FIG. 23.

The downstream output destination determination units 34A and 34B first confirm, based on preset processing method selection information, whether to use the MAC address search table 27 by method A (step 400).

If method A is designated (step 400: YES), the downstream output destination determination units 34A and 34B confirm, based on the entry enable/disable of the destination MAC addresses of received downstream frames in the MAC address search table 27, whether the destination MAC addresses have been registered in the MAC address search table 27 (step 401).

If the “enable” state has been set as the entry enable/disable, and the destination MAC addresses have been registered (step 401: YES), the downstream output destination determination units 34A and 34B read out LLIDs detected from the MAC address search table 27 as the destination LLIDs of the downstream frames (step 402), decide the output systems of the downstream frames from detected pieces of downstream output destination selection information (step 403), and end the series of processes.

In contrast, if the MAC address fields do not match the destination MAC addresses in any entry where the “enable” state is set as the entry enable/disable (step 401: NO), the downstream output destination determination units 34A and 34B decide to discard the downstream frames (step 421), and end the series of processes.

If method B using the VID table 35 is designated in step 400 (step 400: NO), the downstream output destination determination units 34A and 34B confirm whether VLAN tags are included in the received downstream frames (step 410).

If VLAN tags are included (step 410: YES), the downstream output destination determination units 34A and 34B confirm, based on the entry enable/disable of the VIDs of the received downstream frames in the VID table 35, whether the VIDs have been registered in the VID table 35 (step 411).

If the “enable” state has been set as the entry enable/disable, that is, the VIDs have been registered (step 411: YES), the downstream output destination determination units 34A and 34B read out LLIDs corresponding to the VIDs from the VID table 35, and specify the LLIDs as the destination LLIDs of the downstream frames (step 412). The downstream output destination determination units 34A and 34B read out pieces of downstream output destination selection information corresponding to the VIDs from the VID table 35, specify the output systems of the downstream frames (step 413), and end the series of processes.

If the “disable” state has been set as the entry enable/disable, that is, the VIDs of the received downstream frames have not been registered in the VID table 35 (step 411: NO), the downstream output destination determination units 34A and 34B decide to discard the downstream frames (step 421), and end the series of processes.

If no VLAN tag is included in step 410 (step 410: NO), it is confirmed whether untagged frames are permitted (step 420). If untagged frames are permitted (step 420: YES), the process shifts to step 401. If untagged frames are inhibited (step 420: NO), the process shifts to step 421.

The operation is the same as that in the first embodiment except for the downstream output destination determination processing by the downstream output destination determination units 34A and 34B, and the VID table 35.

Values in the VID table 35 are set by determining VIDs for use by external hardware or software (not shown in FIG. 21) at the time of ONU registration by a control frame processing unit 14.

### Effects of Sixth Embodiment

As described above, according to this embodiment, downstream output destination determination processing can be performed based on the VID value in addition to the destination MAC address. Which of the destination MAC address and the VID is used to perform downstream output destination determination processing depends on the system.

Upon receiving a downstream frame, the OLT 10 can embed, to the downstream frame, an LLID corresponding to an ONU belonging to a VLAN indicated by the VID in the header, and send the downstream frame at a downstream rate suited to the ONU.

As in the arrangements according to the first to third embodiments, power supply to a power saving block B2 can be stopped in accordance with the upstream bandwidth allocation and the Discovery Window period, and power of the OLT 10 can be saved.

### Seventh Embodiment

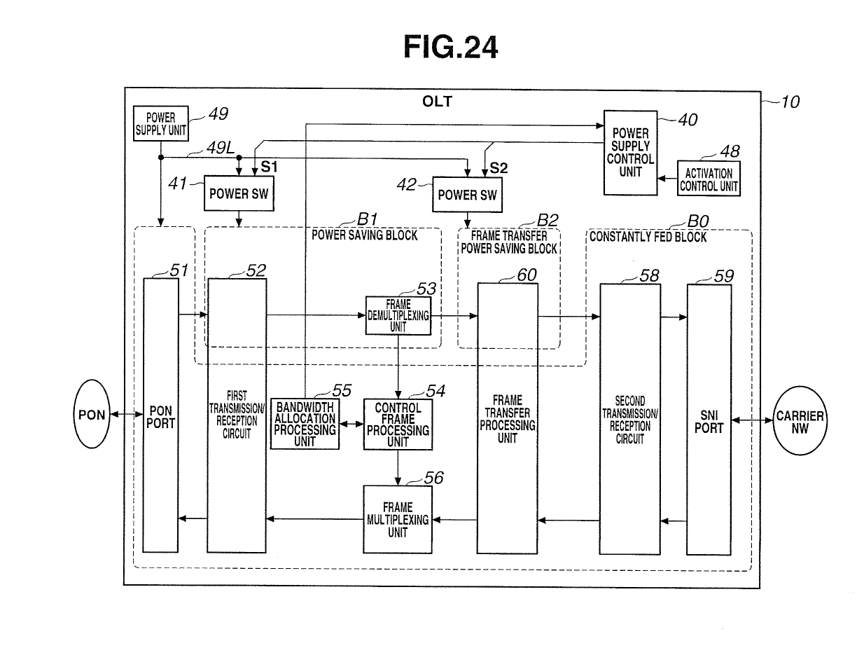

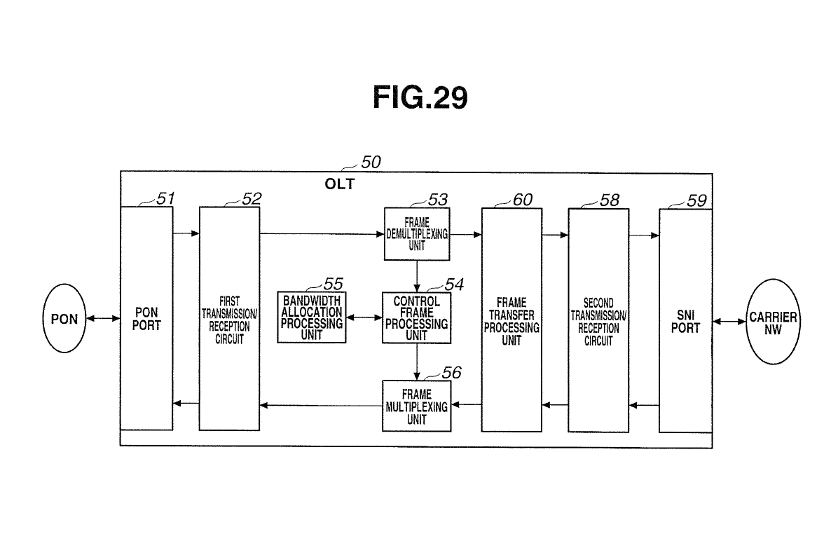

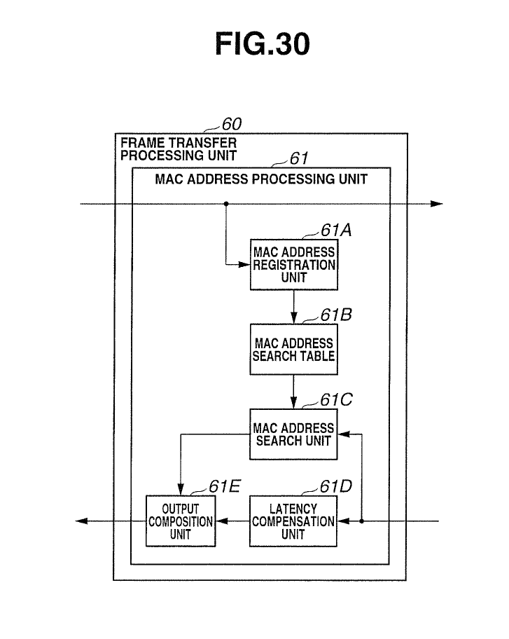

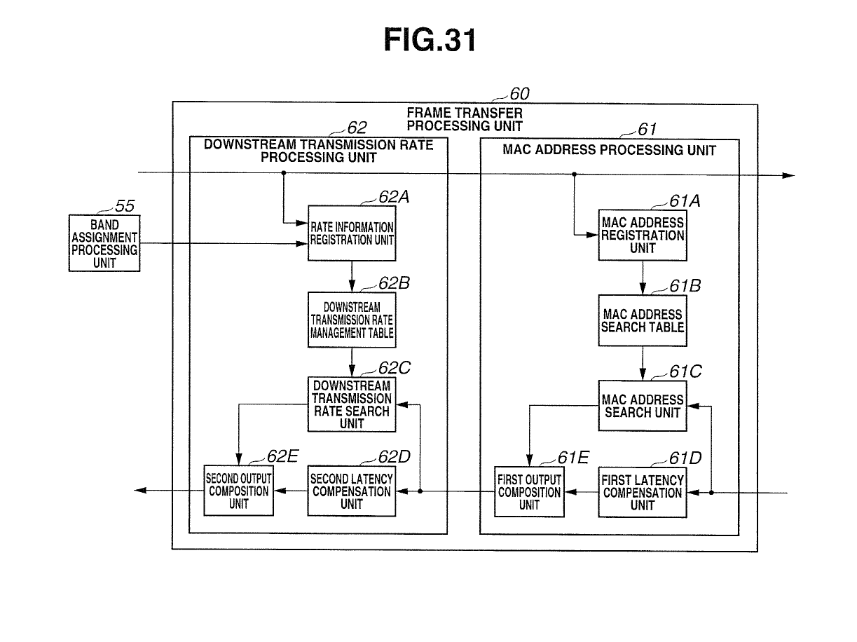

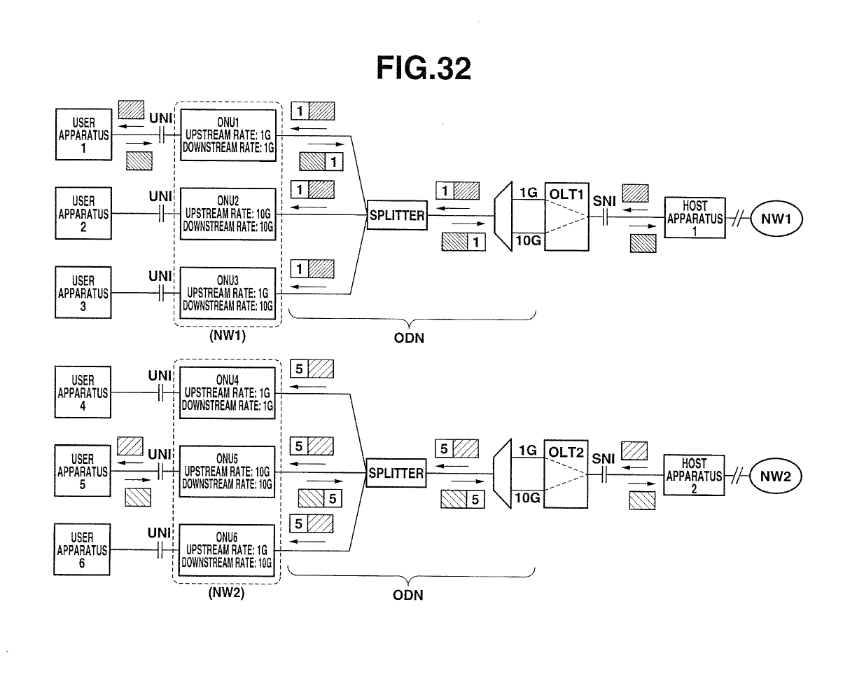

An OLT 10 according to the seventh embodiment of the present invention will be described next with reference to FIGS. 24 and 29.

A first transmission/reception circuit 52 shown in FIG. 24 is equivalent to an integration of the reception circuit 12 and the transmission circuits 17A and 17B by reducing the transmission circuits 17A and 17B in FIG. 3 to only one system. Of the first transmission/reception circuit 52 in FIG. 24, a part equivalent to the reception circuit 12 is included in the power saving block. Pieces of information to be exchanged for power saving are the same.

### Effects of Seventh Embodiment

As described above, according to this embodiment, as in the arrangements according to the first to third embodiments, power supply to the power saving block can be stopped in accordance with the upstream bandwidth allocation and the Discovery Window period, and power of the OLT 10 can be saved.

It is also possible to add the same aging function as in the fifth embodiment to the seventh embodiment.

### Eighth Embodiment

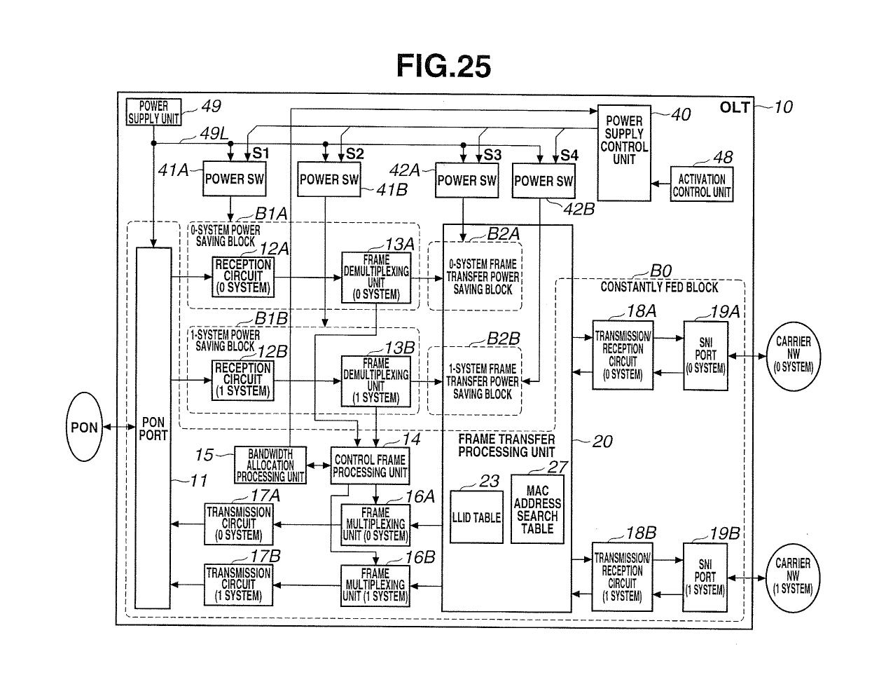

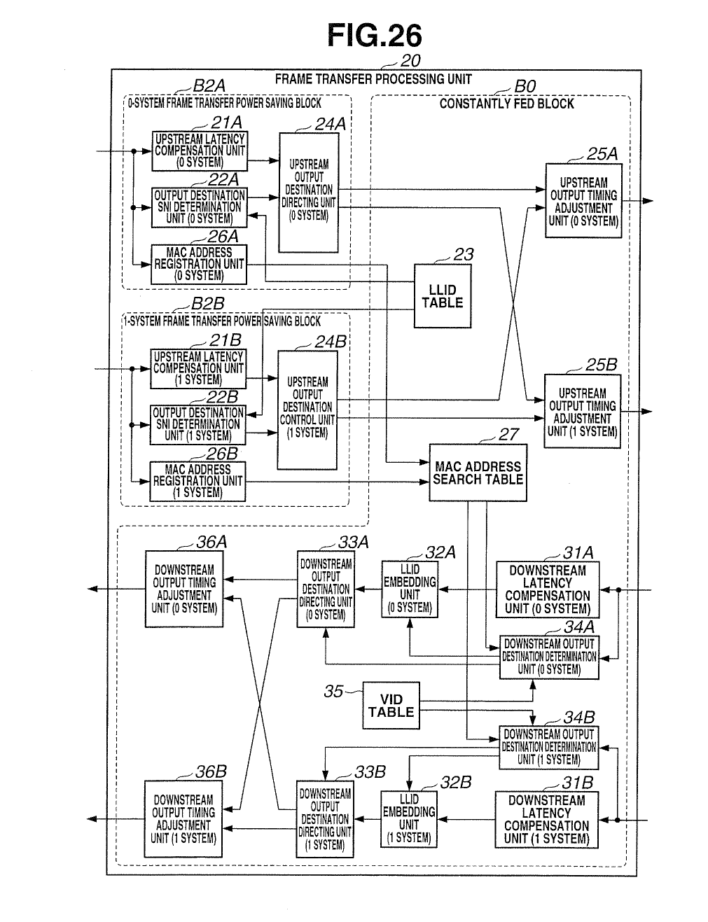

An OLT 10 according to the eighth embodiment of the present invention will be described next with reference to FIGS. 25 and 26.

In the arrangement of FIG. 25, the OLT 10 includes upstream data paths for two, 0 and 1 systems, and performs upstream signal reception processing, frame demultiplexing processing, and frame transfer processing (part) by the circuits of the respective systems.

Further, the OLT 10 has a function of controlling supply/stop of power in accordance with the upstream bandwidth allocations and Discovery Window periods of the respective systems.

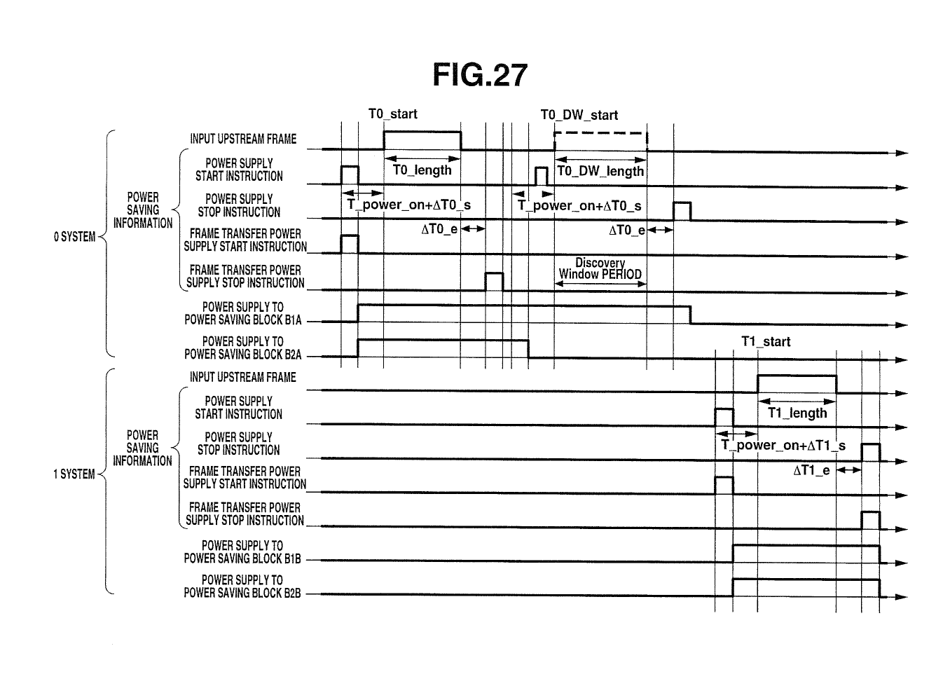

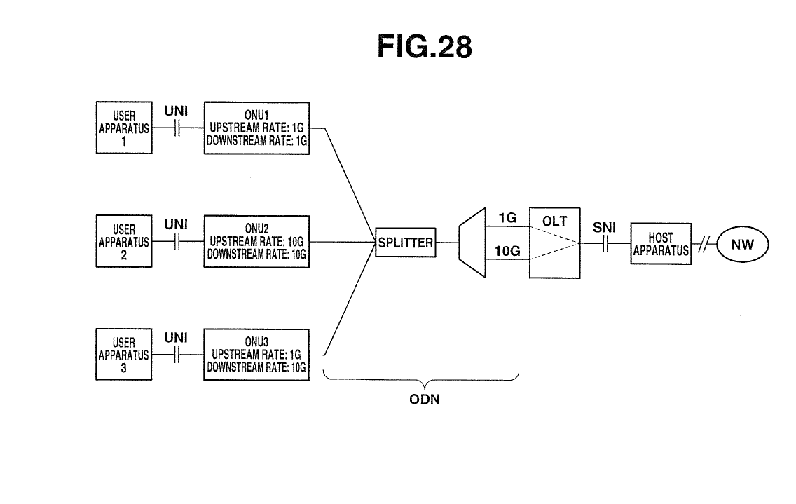

As the respective systems, for example, the 0 system is a 1-Gbps system and the 1 system is a 10-Gbps system. The data rate between the OLT and the ONU is 1 Gbps upstream and 1 Gbps downstream in a GE-PON ONU, 10 Gbps upstream and 10 Gbps downstream in a symmetrical 10 G-EPON ONU, and 1 Gbps upstream and 10 Gbps downstream in an asymmetrical 10 G-EPON ONU. In the eighth embodiment, one system in the first embodiment is divided into two. When a reception circuit 12 is divided for the respective systems, as in this embodiment, the OLT can easily cope with a case in which, for example, the cipher system differs between the 0 system and the 1 system. Further, when values such as a margin are different between the respective systems, optimal values can be selected to improve the power saving effects, as distinctively represented in the timing chart of FIG. 27.

All of a reception circuit (0 system) 12A and a frame demultiplexing unit (0 system) 13A concerning reception of a 0-system upstream frame belong to a 0-system power saving block B1A. Some of circuits concerning reception of a 0-system upstream frame in a frame transfer processing unit 20 but not concerning Discovery processing among circuits concerning reception of a 0-system upstream frame belong to a 0-system frame transfer power saving block B2A. All of a reception circuit (1 system) 12B and a frame demultiplexing unit (1 system) 13B concerning reception of a 1-system upstream frame belong to a 1-system power saving block B1B. Some of circuits concerning reception of a 1-system upstream frame in the frame transfer processing unit 20 but not concerning Discovery processing among circuits concerning reception of a 1-system upstream frame belong to a 1-system frame transfer power saving block B2B. Some of circuits concerning reception of upstream frames of both the 0 and 1 systems in the frame transfer processing unit 20 belong to a frame transfer power saving block B2.

As shown in FIG. 26, the frame transfer processing unit according to the eighth embodiment is different from the frame transfer processing unit in FIG. 4 (first embodiment) in that upstream latency compensation units 21, output destination SNI determination units 22, MAC address registration units 26, and upstream output destination directing units 24 are arranged for the two, 0 and 1 systems. In addition, the frame transfer processing unit according to the eighth embodiment is different in the section of the power saving block. An upstream latency compensation unit (0 system) 21A, an output destination SNI determination unit (0 system) 22A, an upstream output destination directing unit (0 system) 24A, and a MAC address registration unit (0 system) 26A belong to the 0-system frame transfer power saving block B2A. An upstream latency compensation unit (1 system) 21B, an output destination SNI determination unit (1 system) 22B, an upstream output destination directing unit (1 system) 24B, and a MAC address registration unit (1 system) 26B belong to the 1-system frame transfer power saving block B2B.

Next, power supply stop/start processing to each power saving block according to the eighth embodiment will be explained in detail with reference to FIG. 27.

As shown in FIG. 27, a bandwidth allocation processing unit 15 calculates pieces of upstream bandwidth allocation information of the 0 and 1 systems (0-system upstream frame reception start time T0_start, 0-system reception period T0_length, 1-system upstream frame reception start time T1_start, and 1-system reception period T1_length). When restarting power supply to the 0-system power saving block B1A, the bandwidth allocation processing unit 15 transmits a 0-system power supply start instruction (pulse signal) to a power supply control unit 40 a predetermined time before the 0-system upstream frame reception start time, that is, at time (T0_start−T_power_on−ΔT0_s) in consideration of a time T_power_on taken to activate the power saving block and a margin ΔT0_s. When stopping power supply to the 0-system power saving block B1A, the bandwidth allocation processing unit 15 transmits a 0-system power supply stop instruction (pulse signal) to the power supply control unit 40 a predetermined time after the 0-system upstream frame reception completion time, that is, at time (T0_start+T0_length+ΔT0_e) in consideration of a margin ΔT0_e.

Similarly, when restarting power supply to the 1-system power saving block B1B, the bandwidth allocation processing unit 15 transmits a 1-system power supply start instruction (pulse signal) to the power supply control unit 40 a predetermined time before the 1-system upstream frame reception start time, that is, at time (T1_start−T_power_on−ΔT1_s) in consideration of the time T_power_on taken to activate the power saving block and a margin ΔT1_s. When stopping power supply to the 1-system power saving block BIB, the bandwidth allocation processing unit 15 transmits a 1-system power supply stop instruction (pulse signal) to the power supply control unit 40 a predetermined time after the 1-system upstream frame reception completion time, that is, at time (T1_start+T1_length+ΔT1_e) in consideration of a margin ΔT1_e.

When the difference between the first 0-system power supply stop time and the subsequent second 0-system power supply start time is equal to or smaller than a predetermined time, the bandwidth allocation processing unit 15 sends neither the 0-system power supply stop instruction nor the 0-system power supply start instruction to the power supply control unit 40 at an interval between the first 0-system power supply and the second 0-system power supply (shown in FIG. 27).

Similarly, when the difference between the first 1-system power supply stop time and the subsequent second 1-system power supply start time is equal to or smaller than a predetermined time, the bandwidth allocation processing unit 15 sends neither the 1-system power supply stop instruction nor the 1-system power supply start instruction to the power supply control unit 40 at an interval between the first 1-system power supply and the second 1-system power supply (not shown in FIG. 27).

Further, the bandwidth allocation processing unit 15 calculates pieces of Discovery Window information of the 0 and 1 systems (0-system Discovery Window start time T0_DW_start, 0-system Discovery Window length T0_DW_length, 1-system Discovery Window start time T1_DW_start, and 1-system Discovery Window length T1_DW_length).

Before and after a period in which a 0-system upstream bandwidth is allocated, the bandwidth allocation processing unit 15 transmits a 0-system power supply start instruction, a 0-system power supply stop instruction, a 0-system frame transfer power supply start instruction, and a 0-system frame transfer power supply stop instruction (pulse signals) to the power supply control unit 40 to restart/stop power supply to the 0-system power saving block B1A and the 0-system frame transfer power saving block B2A. Before and after the 0-system Discovery Window period, the bandwidth allocation processing unit 15 transmits only a 0-system power supply start instruction and a 0-system power supply stop instruction (pulse signals) to the power supply control unit 40, and transmits neither a 0-system frame transfer power supply start instruction nor a 0-system frame transfer power supply stop instruction (pulse signals) (shown in FIG. 27).

Similarly, before and after a period in which a 1-system upstream bandwidth is allocated, the bandwidth allocation processing unit 15 transmits a 1-system power supply start instruction, a 1-system power supply stop instruction, a 1-system frame transfer power supply start instruction, and a 1-system frame transfer power supply stop instruction (pulse signals) to the power supply control unit 40 to restart/stop power supply to the 1-system power saving block B1B and the 1-system frame transfer power saving block B2B. Before and after the 1-system Discovery Window period, the bandwidth allocation processing unit 15 transmits only a 1-system power supply start instruction and a 1-system power supply stop instruction (pulse signals) to the power supply control unit 40, and transmits neither a 1-system frame transfer power supply start instruction nor a 1-system frame transfer power supply stop instruction (pulse signals) (not shown in FIG. 27).

When the bandwidth allocation processing unit 15 transmits the 0-system power supply start instruction to the power supply control unit 40, a power switch 41A is closed in accordance with a control signal S1A to supply power to the 0-system power saving block B1A. When the bandwidth allocation processing unit 15 transmits the 0-system power supply stop instruction to the power supply control unit 40, the power switch 41A is opened in accordance with the control signal S1A to stop the power supply to the 0-system power saving block B1A.

When the bandwidth allocation processing unit 15 transmits the 0-system frame transfer power supply start instruction to the power supply control unit 40, a power switch 42A is closed in accordance with a control signal S2A to supply power to the 0-system frame transfer power saving block B2A. When the bandwidth allocation processing unit 15 transmits the 0-system frame transfer power supply stop instruction to the power supply control unit 40, the power switch 42A is opened in accordance with the control signal S2A to stop the power supply to the 0-system frame transfer power saving block B2A.

When the bandwidth allocation processing unit 15 transmits the 1-system power supply start instruction to the power supply control unit 40, a power switch 41B is closed in accordance with a control signal S1B to supply power to the 1-system power saving block B1B. When the bandwidth allocation processing unit 15 transmits the 1-system power supply stop instruction to the power supply control unit 40, the power switch 41B is opened in accordance with the control signal S1B to stop the power supply to the 1-system power saving block BIB.

When the bandwidth allocation processing unit 15 transmits the 1-system frame transfer power supply start instruction to the power supply control unit 40, a power switch 42B is closed in accordance with a control signal S2B to supply power to the 1-system frame transfer power saving block B2B. When the bandwidth allocation processing unit 15 transmits the 1-system frame transfer power supply stop instruction to the power supply control unit 40, the power switch 42B is opened in accordance with the control signal S2B to stop the power supply to the 1-system frame transfer power saving block B2B.

The 0-system bandwidth allocation period, the 0-system Discovery Window period, the 1-system bandwidth allocation period, and the 1-system Discovery Window period do not overlap each other. However, it is not a problem even if power is supplied to the 1 system in the 0-system bandwidth allocation period or the 0-system Discovery Window period. Also, it is not a problem even if power is supplied to the 0 system in the 1-system bandwidth allocation period or the 1-system Discovery Window period.

Power supply to the 1 system can be stopped in the 0-system bandwidth allocation period or the 0-system Discovery Window period. Similarly, power supply to the 0 system can be stopped in the 1-system bandwidth allocation period or the 1-system Discovery Window period.

Further, power supply to the 0-system frame transfer power saving block B2A and the 1-system frame transfer power saving block B2B can be stopped in the 0-system Discovery Window period or the 1-system Discovery Window period.

### Effects of Eighth Embodiment

As described above, in this embodiment, the power saving blocks B1A and B1B are provided by division for a plurality of upstream transmission systems (0 system and 1 system) having different upstream frame transfer rates. When the power supply control unit 40 supplies power to the power saving blocks B1A and B1B of the respective upstream transmission systems, the periods of upstream bandwidths allocated to ONUs that use these upstream transmission systems are used as the periods of upstream bandwidths.

In this embodiment, the power saving blocks B1A and B1B and the frame transfer power saving blocks B2A and B2B are provided by division for a plurality of upstream transmission systems (0 system and 1 system) having different upstream frame transfer rates. When the power supply control unit 40 supplies power to the power saving blocks B1A and B1B and frame transfer power saving blocks B2A and B2B of the respective upstream transmission systems, the periods of upstream bandwidths and Discovery Window periods allocated to ONUs that use these upstream transmission systems are used as the periods of upstream bandwidths.

Therefore, the OLT can individually cope with upstream frames of a plurality of systems (for example, 0 system: 1 Gbps, 1 system: 10 Gbps).

As in the arrangements according to the first to third embodiments, power supply to the frame transfer power saving blocks B2A and B2B can be stopped in accordance with the upstream bandwidth allocation and the Discovery Window period, and power of the OLT 10 can be saved.

The same functions as those in the fourth, fifth, and sixth embodiments can also be added to the eighth embodiment.

### Extension of Embodiments

The present invention has been described above by referring to the embodiments, but is not limited to these embodiments. Various changes understandable by those skilled in the art can be made for the arrangements and details of the present invention without departing from the scope of the invention. In addition, the embodiments can be arbitrarily combined and implemented within a consistent range.

In the timing charts (see FIGS. 9, 10, and 13) according to the first to third embodiments, a power supply start instruction, a power supply stop instruction, a frame transfer power supply start instruction, and a frame transfer power supply stop instruction are pulse signals. However, the start and stop may be designated by a level signal or a register setting.

The level signal means power supply to the power saving block B1 in FIG. 9 (lowest signal), and expresses control of supplying power while the control signal S1 keeps high level (H) during the supply period. As the register setting, value 1 is sent as S1 to the power SW at the beginning of the supply period, and is held in the power SW (having a holding function). At the end of the supply period, value 0 is sent as S1 to the power SW, and held in the power SW (having the holding function). The power SW supplies power in a period in which value 1 is held. S1 is a pulse signal. That is, S1 for power supply control to the power saving block B1 may be the level signal or the pulse signal.

In the block diagrams (see FIGS. 11, 14, 24, and 25) according to the third, fourth, seventh, and eighth embodiments, the frame transfer processing unit 20 controls at once the power supplies of the power saving blocks B1A and B1B positioned on the side of the PON port 11 through one frame path by opening/closing the power switch 41 in accordance with the control signal S1. Alternatively, by opening/closing a plurality of power switches in accordance with a plurality of control signals, the power supplies of the plurality of power saving blocks B1A and B1B constituting a single frame path may be individually controlled.

The frame path means a frame path or frame processing path configured by a plurality of frame processing functions of the 0 system constituted by the frame multiplexing unit 16A and the transmission circuit 17A, and the 1 system constituted by the frame multiplexing unit 16B and the transmission circuit 17B. In other words, the power supplies of the plurality of power saving blocks constituting a single frame path may be individually controlled, or the power supplies of parts constituting the power saving block may be individually controlled.

Also, the power supplies of parts constituting the power saving block may be individually controlled. For example, the power supplies may be sequentially controlled in the same order as that in which frame processing proceeds. In the above example, the power supply control unit 40 outputs, based on power saving information transmitted from the bandwidth allocation processing unit 15, the control signal S1 for the power saving blocks B1A and B1B positioned on the side of the PON port 11 with respect to the frame transfer processing unit 20. However, the power supply control unit 40 may output the control signal S1 based on both or the latter one of power saving information transmitted from the bandwidth allocation processing unit 15 and information transmitted from a block other than the bandwidth allocation processing unit 15. For example, the power supply control unit 40 may output the control signal based on downstream output destination selection information transmitted from the upstream input unit, and individually control the power supply of a part constituting the upstream input unit.

As the power saving information, information indicating the start/end timing of an upstream bandwidth allocated to an GNU may be used. Based on this power saving information, the power supply control unit 40 may specify the supply/stop timing of the power supply to the power saving block or/and the frame transfer power saving block.

Further, as the power saving information, information indicating the start/end timing of the Discovery Window period may be used. Based on this power saving information, the power supply control unit 40 may specify the supply/stop timing of the power supply to the power saving block or/and the frame transfer power saving block.

In the above-described embodiments, the power consumption is reduced by stopping power supply to the power saving block. However, the present invention is not limited to this. For example, power may be saved by controlling the power supply voltage to be low, and the same operation effects as those in the above-described embodiments can be obtained. Also, for example, power may be saved by supplying/stopping a processing operation clock signal that is input to the power saving block, and the same operation effects as those in the above-described embodiments can be obtained. For example, power may be saved by controlling the clock frequency to be low, and the same operation effects as those in the above-described embodiments can be obtained. For example, power may be saved by controlling a substrate bias and reducing a leakage current, and the same operation effects as those in the above-described embodiments can be obtained.

### EXPLANATION OF THE REFERENCE NUMERALS AND SIGNS

100 . . . PON system, 10 . . . OLT, 11 . . . PON port, 12 . . . reception circuit, 12A . . . upstream input unit, 13 . . . frame demultiplexing unit, 14 . . . control frame processing unit, 15 . . . bandwidth allocation processing unit, 16A . . . frame multiplexing unit (0 system), 16B . . . frame multiplexing unit (1 system), 17A . . . transmission circuit (0 system), 17B . . . transmission circuit (1 system), 18A . . . transmission/reception circuit (0 system), 18B . . . transmission/reception circuit (1 system), 19A . . . SNI port (0 system), 19B . . . SNI port (1 system), 20 . . . frame transfer processing unit, 21 . . . upstream latency compensation unit, 22 . . . output destination SNI determination unit, 23 . . . LLID table, 24 . . . upstream output destination directing unit, 25A . . . upstream output timing adjustment unit (0 system), 25B . . . upstream output timing adjustment unit (1 system), 26 . . . MAC address registration unit, 27 . . . MAC address search table, 31A . . . downstream latency compensation unit (0 system), 31B . . . downstream latency compensation unit (1 system), 32A . . . LLID embedding unit (0 system), 32B . . . LLID embedding unit (1 system), 33A . . . downstream output destination directing unit (0 system), 33B . . . downstream output destination directing unit (1 system), 34A . . . downstream output destination determination unit (0 system), 34B . . . downstream output destination determination unit (1 system), 35 . . . VID table, 36A . . . downstream output timing adjustment unit (0 system), 36B . . . downstream output timing adjustment unit (1 system), 40 . . . power supply control unit, 41 . . . power switch, 48 . . . activation control unit, 49 . . . power supply unit, B0 . . . constantly fed block, B1 . . . power saving block, B2 . . . frame transfer power saving block, B1A . . . 0-system power saving block, B1B . . . 1-system power saving block, B2A . . . 0-system frame transfer power saving block, B2B . . . 1-system frame transfer power saving block

1. An OLT comprising:
a reception circuit that receives upstream frames from a plurality of ONUs connected via a PON in periods of upstream bandwidths individually allocated to the respective ONUs;
one or a plurality of transmission circuits that are provided for respective preset downstream transmission rates and transmit downstream frames to the ONUs via the PON at the downstream transmission rates;
a transmission/reception circuit that transmits the upstream frame to a host apparatus connected via an SNI (Service Node Interface) and receives the downstream frame from the host apparatus via the SNI;
a frame demultiplexing unit that demultiplexes the upstream frame received by said reception circuit into an SNI upstream frame to be transferred to the SNI side and a non-SNI upstream frame unnecessary to be transferred to the SNI side;
a frame transfer processing unit that transfers the SNI upstream frame demultiplexed by said frame demultiplexing unit to said transmission/reception circuit, and transfers the downstream frame received by said transmission/reception circuit to said transmission circuit; and
a power supply control unit that selectively supplies power to a power saving block constituted by at least one circuit unit used for reception processing of the upstream frame, out of circuit units including said reception circuit, said plurality of transmission circuits, said transmission/reception circuit, said frame demultiplexing unit, and said frame transfer processing unit which constitute the OLT, and constantly supplies power to a constantly fed block constituted by a circuit unit other than the power saving block,
wherein when supplying power to the power saving block, said power supply control unit starts power supply in synchronism with a start of the period of the upstream bandwidth of each ONU, and stops the power supply in synchronism with an end of the period of the upstream bandwidth.

2. The OLT according to claim 1, wherein the power saving block includes at least one of said reception circuit and said frame demultiplexing unit.

3. The OLT according to claim 1, wherein the period of the upstream bandwidth includes, based on an amount of upstream data waiting for transmission in the ONU that is notified from the ONU, a period of an upstream bandwidth used to transmit an upstream frame from each ONU, and a period of an upstream bandwidth used to transmit a upstream control frame from the ONU.

4. The OLT according to claim 1, wherein
said power supply control unit starts, in addition to the power supply synchronized with the period of the upstream bandwidth allocated to each ONU, power supply to the power saving block in synchronism with a start of a Discovery Window period for waiting for an LLID registration request notified from each ONU, and stops the power supply in synchronism with an end of the Discovery Window period, and
said power supply control unit starts power supply in synchronism with the start of the period of the upstream bandwidth allocated to each ONU to a frame transfer power saving block constituted by at least one circuit unit that is provided in said frame transfer processing unit and is used in transfer processing for transferring the upstream frame received by said reception circuit to said transmission/reception circuit corresponding to the upstream frame, stops the power supply in synchronism with the end of the period of the upstream bandwidth, and stops power supply to the frame transfer power saving block in the Discovery Window period.

5. The OLT according to claim 1, wherein
the power saving block includes power saving blocks that are provided for respective upstream transmission systems having different upstream frame transfer rates, and
when supplying power to the power saving block of each upstream transmission system, said power supply control unit starts power supply in synchronism with the start of the period of the upstream bandwidth allocated to each ONU using the upstream transmission system, and stops the power supply in synchronism with the end of the period of the upstream bandwidth.

6. The OLT according to claim 4, wherein
the power saving block and the frame transfer power saving block include power saving blocks and frame transfer power saving blocks that are provided for respective upstream transmission systems having different upstream frame transfer rates,
said power supply control unit performs the power supply to the power saving block of each upstream transmission system in synchronism with the period of the upstream bandwidth allocated to each ONU using the upstream transmission system, and the Discovery Window period, and
said power supply control unit performs the power supply to the frame transfer power saving block of each upstream transmission system in synchronism with the period of the upstream bandwidth allocated to each ONU using the upstream transmission system.

7. A frame transfer method comprising:
the step of causing a reception circuit to receive upstream frames from a plurality of ONUs connected via a PON in periods of upstream bandwidths individually allocated to the respective ONUs;
the step of causing transmission circuits provided for respective preset downstream transmission rates to transmit downstream frames to the ONUs via the PON at the downstream transmission rates;
the step of causing a transmission/reception circuit to transmit the upstream frame to a host apparatus connected via an SNI (Service Node Interface);
the step of causing the transmission/reception circuit to receive the downstream frame from the host apparatus via the SNI;
the step of causing a frame demultiplexing unit to demultiplex the upstream frame received by the reception circuit into an SNI upstream frame to be transferred to the SNI side and a non-SNI upstream frame unnecessary to be transferred to the SNI side;
the step of causing a frame transfer processing unit to transfer the SNI upstream frame demultiplexed by the frame demultiplexing unit to the transmission/reception circuit;
the step of causing the frame transfer processing unit to transfer the downstream frame received by the transmission/reception circuit to the transmission circuit;
the power saving supply step of causing a power supply control unit to selectively supply power to at least one circuit unit that is included in a power saving block, out of circuit units including the reception circuit, the plurality of transmission circuits, the transmission/reception circuit, the frame demultiplexing unit, and the frame transfer processing unit which constitute the OLT, and is used for reception processing of the upstream frame; and
the step of causing the power supply control unit to constantly supply power to, of the circuit units, a circuit unit included in a constantly fed block other than the power saving block,
the power saving supply step including the step of starting power supply to the power saving block in synchronism with a start of the period of the upstream bandwidth of each ONU, and the step of stopping the power supply to the power saving block in synchronism with an end of the period of the upstream bandwidth of the ONU.

8. The frame transfer method according to claim 7, wherein the power saving block includes at least one of the reception circuit and the frame demultiplexing unit.

9. The frame transfer method according to claim 7, wherein the period of the upstream bandwidth includes, based on an amount of upstream data waiting for transmission in the ONU that is notified from the ONU, a period of an upstream bandwidth used to transmit an upstream frame from each ONU, and a period of an upstream bandwidth used to transmit a upstream control frame from the ONU.

10. The frame transfer method according to claim 7, further comprising:
the step of causing the power supply control unit to start, in addition to the power supply synchronized with the period of the upstream bandwidth allocated to each ONU, power supply to the power saving block in synchronism with a start of a Discovery Window period for waiting for an LLID registration request notified from each ONU, and stop the power supply in synchronism with an end of the Discovery Window period; and
the step of causing the power supply control unit to start power supply in synchronism with the start of the period of the upstream bandwidth of each ONU to a frame transfer power saving block constituted by at least one circuit unit that is provided in the frame transfer processing unit and is used in transfer processing for transferring the upstream frame received by the reception circuit to the transmission/reception circuit corresponding to the upstream frame, stop the power supply in synchronism with the end of the period of the upstream bandwidth, and stop power supply to the frame transfer power saving block in the Discovery Window period.

11. The frame transfer method according to claim 7, wherein
the power saving block includes power saving blocks that are provided for respective upstream transmission systems having different upstream frame transfer rates, and
the frame transfer method further comprises the step of, when supplying power to the power saving block of each upstream transmission system, causing the power supply control unit to start power supply in synchronism with the start of the period of the upstream bandwidth allocated to each ONU using the upstream transmission system, and stop the power supply in synchronism with the end of the period of the upstream bandwidth.

12. The frame transfer method according to claim 10, wherein
the power saving block and the frame transfer power saving block include power saving blocks and frame transfer power saving blocks that are provided for respective upstream transmission systems having different upstream frame transfer rates, and
the frame transfer method further comprises:
the step of causing the power supply control unit to perform the power supply to the power saving block of each upstream transmission system in synchronism with the period of the upstream bandwidth allocated to each ONU using the upstream transmission system, and the Discovery Window period, and
the step of causing the power supply control unit to perform the power supply to the frame transfer power saving block of each upstream transmission system in synchronism with the period of the upstream bandwidth allocated to each GNU using the upstream transmission system.
